(19) United States
(12) Patent Application Publication
(10) Pub. No.: US 2020/0349570 A1
(43) Pub. Date: Nov. 5, 2020

(54) SYSTEM AND METHOD FOR ENHANCED CLOCK AUCTIONS AND COMBINATORIAL CLOCK AUCTIONS

(71) Applicant: EFFICIENT AUCTIONS LLC, Washington, DC (US)

(72) Inventors: Lawrence M. AUSUBEL, Washington, DC (US); Oleg V. BARANOV, Boulder, CO (US)

(73) Assignee: EFFICIENT AUCTIONS LLC, Washington, DC (US)

(21) Appl. No.: 16/730,315

(22) Filed: Dec. 30, 2019

Related U.S. Application Data
(63) Continuation of application No. 13/843,338, filed on Mar. 15, 2013, now abandoned.
(60) Provisional application No. 61/768,876, filed on Feb. 25, 2013.

(51) Int. Cl. G06Q 20/40; G06Q 30/08; G06N 5/04

(52) U.S. Cl. CPC G06Q 20/405; G06Q 40/06; G06N 5/04; G06Q 30/08

(57) ABSTRACT

The present invention provides improvements applicable to dynamic auctions such as clock auctions or combinatorial clock auctions. In a first embodiment, the present invention includes an improved activity rule that constrains the bids that may be submitted by a bidder, based on the bidder's own prior bids, In a second embodiment, the present invention includes an improved pricing rule that appropriately discounts the amounts (as compared to linear pricing) of bids that need to be submitted by a bidder. In a third embodiment, the present invention includes an improved iterative first-price auction. Bidders successively make bids, often a bid for a package of items at a specified price. When the auction concludes, some of these bids become “winning” bids; the respective bidders win the items specified in their winning bids and pay the prices specified in their winning bids. In some preferred embodiments, the present invention combines two or all three of these improvements.

### CROSS REFERENCE TO RELATED APPLICATIONS

This application is a continuation of U.S. application Ser. No. 13/843,338, filed on Mar. 15, 2013, which claims the benefit of priority to U.S. Provisional Application No. 61/768,876, filed on Feb. 25, 2013. The disclosures of the aforementioned applications are hereby incorporated by reference in their entireties.

### FIELD OF THE INVENTION

The present invention relates to improving computer-implemented auctions and, more particularly, to improving computer-implemented auctions that include elements of clock auctions and/or combinatorial auctions.

### BACKGROUND OF THE INVENTION

Sellers and buyers of commodities, assets, and other goods and services are increasingly turning to auctions to assist in the sale or purchase of a wide range of items. Auctions are useful for selling a unique item (e.g., a painting), multiple heterogeneous items (e.g., several paintings), a single type of item available in multiple units (e.g., 10 kilograms of gold), and multiple types of items available in multiple units (e.g., 10 kilograms of gold and 20 kilograms of silver). And just as auctions are useful for selling items efficiently or at maximum price, they are also useful for procuring items efficiently or at minimum cost.

The design of an efficient auction, a revenue-maximizing auction or a cost-minimizing auction becomes a particularly difficult problem, technically, when the items are related.

When items are related, they are often related so as to be complements or substitutes. Two items are said to be complements when they are used together; more precisely, items A and B are complements when reducing the price of item A causes the demand for item B to increase. Two items are said to be substitutes when one is used in place of the other; more precisely, items A and B are substitutes when reducing the price of item A causes the demand for item B to fall.

One example of allocating complementary items may be the case of allocating licenses for telecommunications spectrum. A government may offer a variety of spectrum licenses, each covering a specified bandwidth in a specified geographic area. A wireless telephone company seeking spectrum rights may find that it requires a minimum of 20 MHz of bandwidth in a given geographic area, in order to be able to provide a useful service. Thus, two 10 MHz licenses covering the same geographic area may be complements. At the same time, a wireless telephone company may realize synergies from serving two geographically adjacent markets, so licenses for two adjacent markets may also be complements.

One example of allocating substitute items may be the case of allocating electricity contracts. A seller may offer three-month, six-month and one-year electricity contracts, all starting on the same date. For a buyer, these different durations are likely to be substitutes to at least a certain extent, since they each provide electricity for the initial three months.

In some of the most difficult situations some items are complements and other items are substitutes within the same allocation problem. For example, consider the case of allocating capacity at one or more capacity-constrained airport. The airport authority may offer a variety of landing slots and takeoff slots at different times of the day. Various slots may be complementary goods: for example, an airline is likely to desire a takeoff slot about one hour after each landing slot, and an airline may desire several takeoff and landing slots bunched together in order to be able to maintain a “hub-and-spoke” operation. Also, various slots may be substitute goods: for example, an airline may be able to use a 10:00 am landing slot in place of a 9:00 am landing slot, although the former slot may not be anywhere as valuable as the latter slot. The slots at two airports serving the same city are likely to be substitutes for one another, while the slots at two ends of a heavily trafficked route are likely to be complementary goods.

In recent years, there has been growing use of auction processes that allow bidders much greater freedom to bid on multiple items and to name the packages of items on which they bid during the auction. Such auctions, which may determine the packaging, pricing and allocation decisions, are referred to as “combinatorial auctions,” “package auctions,” or “auctions with package bidding.” Typically, bidders in these auctions describe the packages that they wish to acquire and make bids, often ail-or-nothing bids, for the named packages.

One especially promising version of an auction for multiple items, which will sometimes utilize package bids, is a clock auction. It is a dynamic auction process in which the auctioneer announces prices, bidders respond with quantities, the prices are adjusted according to the relation between the quantities bid and the quantities being auctioned, and the process is allowed to repeat. Such auction processes are effective for selling or procuring multiple items, including substitutes and complements. (For a longer discussion, see “System and Method for an Auction of Multiple Types of Items,” U.S. Pat. No. 7,899,734.)

A second especially promising version of an auction for multiple items is a combinatorial clock auction. It is a two-stage process that includes a dynamic auction phase followed by a later phase, the later phase comprising a package auction. The first stage may, for example, be a clock auction, and provides the efficiency and revenue advantages of a clock auction. The second stage allows the bidders to have a final opportunity to submit package bids. The process includes: implementing the dynamic auction phase, determining whether the dynamic auction phase of the auction should continue, changing from the dynamic auction phase to the later phase, implementing the package auction specified for the later phase, determining an allocation of items to bidders based on the bids. Such auction processes are also effective for selling or procuring multiple items, including substitutes and complements. (For a longer discussion, see “System and Method for a Hybrid Clock and Proxy Auction,” U.S. Pat. No. 7,729,975.)

### SUMMARY OF THE INVENTION

The present invention provides improvements applicable to such auctions. In a first set of embodiments, the present invention includes an improved activity rule that constrains the bids that may be submitted by a bidder, based on the bidder's own prior bids. Such activity rules tend to reduce the possibilities for strategic behavior in the auction and improve the quality of information reported throughout the auction, thereby potentially improving the auction's performance. In a second set of embodiments, the present invention includes an improved pricing rule that appropriately discounts the amounts (as compared to linear pricing) of bids that need to be submitted by a bidder. Such pricing rules reduce the need for bidders to submit unnecessarily high bids, thereby potentially improving the auction's performance, particularly when bidders are budget-constrained. In a third set of embodiments, the present invention includes an improved iterative first-price auction. Bidders successively make bids, often a bid for a package of items at a specified price. When the auction concludes, some of these bids become “winning” bids; the respective bidders win the items specified in their winning bids and pay the prices specified in their winning bids. In some preferred embodiments, the present invention combines two or all three of these improvements. In particular, some of the preferred embodiments are iterative first-price auctions in which improved activity rules are imposed on bidders and the improved pricing rules are “supported” or “justified” by the activity rules. The pricing rule is implemented by asking the question: what is the maximum possible “exposure” of a bidder, given that the bidders' opponents are all constrained by a specified activity rule? If the pricing is determined by this approach—that is, if a bidder is never required to bid any higher than its “exposure”—then iterative first pricing yields an auction format with superior performance.

The present invention is an improved system and method for determining or facilitating a computer-implemented allocation of items among at least two parties. For simplicity, we will refer to the allocation of items as an “auction” and to the parties as “bidders”. However, the invention is not limited to the conventional use of the word “auction”; in particular, transactions resulting from the auction may be sales, leases, purchases, licenses, contracts or other relationships or allocations of resources, in either direction (from auctioning party to bidder, or reverse, or simply among the bidders), and it may involve the allocation of resources among machines (which may exchange messages that could be described as machine-generated bids).

Thus, the present invention is also an improved system and method for a computer-implemented auction of multiple items.

Various preferred embodiments of the present invention resolve a number of important limitations to the systems and methods for computer-implemented auctions in the art. Thus, the present invention offers the further technical effect of improving computer-implemented auctions, making them operate more efficiently. The present invention improves the ability to express and resolve conflicting relationships among the items being sold or procured in an auction. The present invention improves the ability of bidders to readily participate in the auction and to express their needs and preferences. The present invention improves the ability of the auctioneer to sell at higher prices the items being sold in the auction or to obtain at lower cost the items being procured in the auction. The present invention improves the efficiency of the auction process by enabling the auction to operate in shorter time, expending less computer time, fewer communications resources, and fess bidder and auctioneer time. Finally, the present invention improves the allocative efficiency of the auction process by better selecting the subset of items that will be transacted and by allocating these items to bidders who value them the highest (or, in a procurement auction, to bidders who can provide them at lowest cost).

Certain constraints are desirable in order for the present invention to operate optimally and to reach an economically efficient outcome. In many auctions, it is desirable to impose constraints on bidders that require them to bid significantly on items early in the auction in order for them to be allowed to bid on items later in the auction. Otherwise, one may find oneself in a situation where bidders refrain from submitting serious bids until near the very end of the auction (“bid sniping”), defeating the purpose of conducting a dynamic auction. One exemplary constraint in the art is an activity rule which constrains a bidder not to increase his quantity of items bid in the auction, from one round to the next. In another exemplary constraint in the art, often referred to as a pure eligibility-point-based activity rule, each item has associated with it a numerical weight (referred to as a number of eligibility points), and the restriction on increase applies not to the quantity of items bid on, but to the sum of the eligibility points of all the items that the bidder bids on (i.e., the weighted sum).

There are four principal problems in the art that the present invention addresses:
(1) It is well understood that a pure eligibility-point-based activity rule will prevent bidders from bidding “straightforwardly”—no matter how cleverly the eligibility points are chosen, bidders will inevitably run into situations where their nave optimal bids are not permitted by an activity rule that requires non-increasing eligibility points. As a result, potential solutions have been introduced in the art, in which “revealed-preference constraints” are imposed on bidders. However, known implementations in the art have had either of two defects: (a) they impose all revealed-preference constraints, but they may produce “dead-ends” in which a bidder finds at a certain point in the auction that he has no legal bids remaining; or (b) they impose only some of the revealed-preference constraints, but then bidders are not adequately induced to bid in a straightforward fashion.
(2) The combinatorial clock auction in the art takes an iterative “second-pricing” approach. Bids for any package in a given round are based on linear pricing; that is, if a bidder bids for package qₜ when the prices of the items are pₜ, the bidder pays the linear product of qₜ and pₜ. However, when the winning bidders' payments are determined, they are based not on their own bids but on essentially the highest losing bids for the items. With this design, bidders are required to make bids at higher prices than they can possibly need to pay at the end of the auction. To the extent that bidders are budget-constrained, this may adversely impact the auction's performance.
(3) The iterative second-pricing in the art also leads to a “missing bids” problem and to an “overbidding” problem. Since payments are based essentially on the highest losing bids for the items, there needs to be an additional opportunity for bidders to submit the bids. In the current art, this occurs in an additional round known as the supplementary round. However, since in some scenarios the supplementary bids have no effect on a bidder's own allocation and only affect his opponents' payments, the bidders may have little incentive to submit these bids—the so-called “missing bids” problem. At the same time, in these scenarios, a bidder who wishes to increase his opponents' prices may be motivated to submit excessive bids that he can calculate will surely be non-winning—the so-called “overbidding” problem.
(4) While an iterative first-price auction would be preferable, the construction of the ideal iterative first-price auction is known only in two environments: the auction of a single item; and the auction of multiple homogeneous goods, where bidders have (weakly) diminishing marginal values.

The present invention solves these problems and thereby provides a practical improvement on the art in the following respects:
(1) Some preferred embodiments of the present invention are improved activity rules, based on the Generalized Axiom of Revealed Preference or refinements of the Generalized Axiom of Revealed Preference. The rule is that a new bid is permitted if and only if the new bid, together with all of the bidder's previous bids, are consistent with the bidder bidding straightforwardly relative to a well-defined set of values. This rule has the advantage of being the most-constraining activity rule that always enables a bidder to bid straightforwardly relative to a well-defined set of values. At the same time, this rule never leads to bidders facing “dead ends”, and it is computationally easy to verify.
(2) Some preferred embodiments of the present invention are improved “iterative first price” auctions. The pricing rule is that the bid that the bidder makes for a given package is only required to be the maximum amount that the bidder could ever be required to pay for the package upon the conclusion of the auction (to the extent that there is no “undersell”, i.e., demand exactly equals supply at the end of the auction). Near the end of the auction, this amount will be strictly less than the linear product of qₜ and pₜ. Consequently, the present invention mitigates the adverse effects of budget constraints on auction performance.
(3) By taking an “iterative first price” approach, some preferred embodiments of the present invention avoid the missing-bids problem. A bidder's payment is not seriously affected by the missing bids of his opponents, as the payment is determined instead primarily by the bidder's own bids. It is not that the incidence of missing bids vanishes; rather, it is that the missing bids no longer constitute a problem. With the “iterative first price” approach, some preferred embodiments of the present invention also avoid the overbidding problem. Excessive bids do not drive up the opponents' payments, as the payments are instead determined primarily by the opponents' own bids. There is no longer any incentive for a bidder to overbid.
(4) Finally, some preferred embodiments of the present invention provide novel iterative first-price auctions in environments where they were not previously known. The auction design combines: (a) the activity rule which permits a new bid if and only if the new bid, together with all of the bidder's previous bids, are consistent with the bidder bidding straightforwardly relative to a well-defined set of values; and (b) the pricing rule which is justified by the activity rule, that is, the bid that the bidder makes for a given package is only required to be the maximum amount that the bidder could ever be required to pay for the package upon the conclusion of the auction, if his opponents are all constrained by the activity rule of (a) and if there is no “undersell”. In particular, some preferred embodiments treat the general environment of allocating multiple items to multiple bidders.

Another way of stating point (4) of the previous paragraph is that: The auction design combines: (a) an activity rule that permits a new bid if and only if the new bid, together with all of the bidder's previous bids, are consistent with a bidder who is bidding in accordance with a consistent set of preferences or objectives (plus any technical assumptions such as quasilinearity or additive separability that may be assumed); and (b) a pricing rule that is justified by the activity rule, that is, the bidder is never required to bid more for a package than an amount that guarantees that the bidder will win this package, if the bidder's opponents are all constrained by the activity rule of (a) (and if the auction were to end now with no “undersell”).

In one preferred embodiment, the present invention is:
A computer system for conducting an auction of a plurality of types of items among a plurality of bidders, said system comprising:
receiving means for receiving bids, each bid specifying items sought and an associated value;
determining means for determining whether to continue the auction based on the received bids;
constraining means for constraining bids that are employed by said determining means, said constraining means constraining bids so that a bid will only be accepted which, when taken together with the bidder's prior bids, reveals a consistent set of objectives; and
pricing means for limiting a value component of a bid so that the value is not required to be greater than an amount which guarantees winning when other bidders' bids are subject to said constraining means.

The case of auctioning a set of items which includes two (or more) items that are neither identical nor perfect substitutes to one another will, henceforth, be described for short as a situation with “multiple types of items,” or simply “heterogeneous items” or “heterogeneous objects.” Often, but not always, the heterogeneous items auctioned together will bear some relationship to one another, for example as complements or substitutes.

Throughout this document, the terms “objects”, “items”, “units”, “goods” and “services” are used essentially interchangeably. The inventive system and method may be used both for tangible objects, such as real or personal property, and intangible items, such as telecommunications licenses, electric power, or consulting services. The inventive system and method may be used in auctions where the auctioneer is a seller, buyer or broker, the bidders are buyers, sellers or brokers, and for auction-like activities which cannot be interpreted as selling or buying. The inventive system and method may be used for items including, but not restricted to, the following: public-sector bonds, bills, notes, stocks, and other securities or derivatives; private-sector bonds, bills, notes, stocks, and other securities or derivatives; communication licenses and spectrum rights; clearing, relocation or other rights concerning encumbrances of spectrum licenses; electric power and other commodity items; rights for terminal, entry, exit or transmission capacities or other rights in gas pipeline systems; airport landing rights; emission allowances and pollution permits; and other goods, services, contracts, instruments, objects, items or other property, tangible or intangible. It may also be used for option contracts or other derivatives on any of the above. It may be used in initial public offerings, secondary offerings, and in secondary or resale markets. And, while the inventive system and method may be usefully applied for financial products and markets, the substantial majority of its applications are for non-financial products and non-financial markets.

The present invention is useful for “reverse auctions” (or “procurement auctions”) conducted by or on behalf of buyers to acquire, procure or purchase various kinds of items or resources, “forward auctions” (or “standard auctions”) conducted by or on behalf of sellers to sell or offer various kinds of items or resources, and “exchanges” (or “two-sided markets”) in which both buyers and sellers place bids. Although terms such as “items or quantities demanded” (by a bidder) and “demand curve” (of a bidder) are used to describe the present invention, the terms “items or quantities offered” (by a bidder) and “supply curve” (of a bidder) are equally applicable. In some cases, this is made explicit by the use of both terms, or by the use of the terms “items or quantities transacted” (by a bidder) and “transaction curve” (of a bidder). The term “items or quantities transacted” includes both “items or quantities demanded” and “items or quantities offered”. The term “bid” includes both offers to sell and offers to buy. The term “transaction curve” includes both “demand curve” and “supply curve”. Moreover, any references to “items or quantities being offered” includes both “items or quantities being sold” by the auctioneer, in the case this is a standard auction for selling items, as well as “items or quantities being bought or procured” by the auctioneer, in the case this is a reverse auction for buying or procuring items.

Moreover, while standard auctions to sell typically involve ascending prices and reverse auctions to buy typically involve descending prices, the present invention may utilize prices that are permitted to ascend and/or descend.

Implementation of the auction on a computer system allows the auction to be conducted swiftly and reliably, even if bidders are not located on-site. Indeed, computer implementation may be most useful when one computer (e.g., a bidder terminal or a bidder's computer) is located remotely from another computer (e.g., a bidding information processor or an auctioneer computer). The auctioneer can receive large numbers of bids, determine the auction outcome, and transmit the results to bidders with minimal labor and in a very short span of time. In particular, sophisticated dynamic auction methods become feasible with a computer implementation; it becomes practical to operate iterative auction procedures in which there may be ten or more auction rounds, yet bidders can participate from different parts of the globe and the entire process can conclude in a single day.

Implementation of the auction on a computer system also makes it practical to control the exact degree to which bid-related information is disclosed to the participants. In one embodiment, all prior bid-related information is disclosed to the bidders. In another embodiment, no bid-related information is disclosed to the bidders; only the final allocation is disclosed. A number of intermediate embodiments are also possible, in which some but not all bid-related information is disclosed to the bidders. For example, in one preferred embodiment, the system discloses only the aggregate number of bids for each item in each round, as opposed to disclosing each individual bid; and in another preferred embodiment, the system discloses only the aggregate number of conflicting bids for each item in each round.

The present invention comprises a computer system that receives bids in a static or dynamic bidding process and assigns the items to bidders, and a method for receiving bids in a static or dynamic bidding process and assigning the items to bidders in the computer system. In one embodiment, the invention comprises a Bidding Information Processor (BIP), a plurality of Bidding Terminals (BTs) communicatively coupled to the BIP, and an Auctioneer's Terminal (AT) communicatively coupled to the BIP. Bidders at the BTs enter bids in multiple rounds, and may observe displayed auction information. The BIP, BTs and AT communicate and process information in order to conduct an auction.

Given recent advances in network computing, particularly cloud computing, the boundaries of what is “a computer” are no longer always clear. For example, computation of a problem may take place on one computer, while computation of sub-problems may take place on other computers. Throughout this document, the terms “a computer”, “a Bidding Information Processor”, etc. shall be interpreted as also including sets of networked computers that interact with the intention of performing a function that could in principle be performed by just a single computer.

Moreover, one or more computers of the computer system may not be classic personal computers or terminals at all, but any device that contains a processor and has the capability of connecting to other processors via a communication system, including but not limited to a “smart phone”, an iPhone, an iPad, an Android device, a Windows device, a Blackberry, a PDA, or a facsimile machine.

The network used, if any, can be any system capable of providing the necessary communication to/from a Bidding Information Processor (BIP), a Bidding Terminal (BT), and an Auctioneer's Terminal (AT). The network may be a local or wide area network such as, for example, Ethernet, token ring, the Internet, the World Wide Web, the information superhighway, an intranet or a virtual private network, or alternatively a telephone system, either private or public, a facsimile system, an electronic mail system, or a wireless communications system, or combinations of the foregoing.

### BRIEF DESCRIPTION OF THE DRAWINGS

FIG. 1 is a graphical depiction of the architecture of an exemplary computer system in accordance with an embodiment of the invention;

FIG. 2 is a graphical depiction of another exemplary computer system in accordance with an embodiment of the invention;

FIG. 3 is a detail of one element of the computer system of FIG. 2;

FIG. 4 is a flow diagram of an exemplary auction process in accordance with one embodiment of the invention;

FIG. 5 is a flow diagram of an exemplary auction process in accordance with one embodiment of the invention;

FIG. 6 is a flow diagram of an exemplary auction process in accordance with one embodiment of the invention;

FIG. 7a is a flow diagram illustrating, in greater detail, an exemplary element of the flow diagrams of FIGS. 4 and 6;

FIG. 7b is a flow diagram illustrating, in greater detail, an exemplary element of the flow diagrams of FIGS. 4 and 6;

FIG. 8a is a flow diagram of an exemplary auction process in accordance with one embodiment of the invention;

FIG. 8b is a flow diagram of an exemplary auction process in accordance with one embodiment of the invention;

FIG. 8c is a flow diagram of an exemplary auction process in accordance with one embodiment of the invention;

FIG. 9 is a flow diagram of an exemplary auction process in accordance with one embodiment of the invention;

FIG. 10a is a flow diagram of an exemplary auction process in accordance with one embodiment of the invention; and

FIG. 10b is a flow diagram of an exemplary auction process in accordance with one embodiment of the invention.

### DETAILED DESCRIPTION OF PREFERRED EMBODIMENTS

### Overall Structure of Auction System

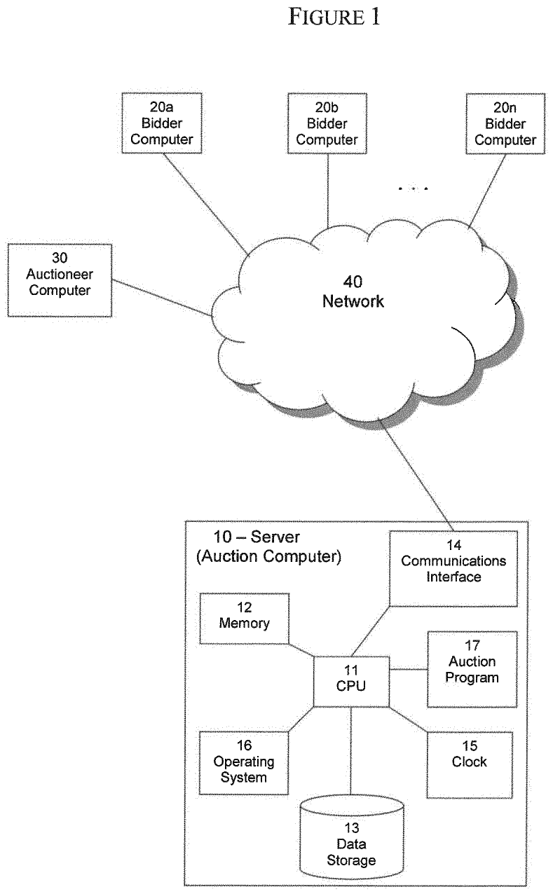

Earlier auction methods and systems are described in U.S. Pat. Nos. 5,905,975, 6,021,398, 6,026,383, 7,062,461, 7,165,046, 7,729,975 and 7,899,734 and in published Application 20040054551. The foregoing patents and published applications are incorporated herein by this reference. All terminology in the following description will incorporate the terminology established in the earlier patents and applications, if not defined herein. The following description will detail the flow of the novel features of the preferred embodiments of the present system and method for clock auctions and combinatorial clock auctions. Before describing the auction process in detail, reference is made to FIG. 1 to describe the architecture of an exemplary computer system in accordance with an embodiment of the present invention. In the graphical depiction of FIG. 1, the computer system consists of multiple bidder and auctioneer computers or terminals 20a-n and 30 communicating with the server (or auction computer) 10 over a network 40. The computers or terminals 20a-n are employed by bidders, the computer or terminal 30 is employed by the auctioneer, and the server 10 is the auction computer. The server 10 consists of a CPU 11, memory 12, a data storage device 13, a communications interface 14, a clock 15, an operating system 16, and an auction program 17. In one embodiment, the system architecture is as a client-server system: the auction computer is a server; and the bidder and auctioneer computers are clients. In many of the most useful embodiments, the auction is implemented on at least two computers, including a first computer and at least one other computer which is located remotely from the first computer and interconnected by a communication system.

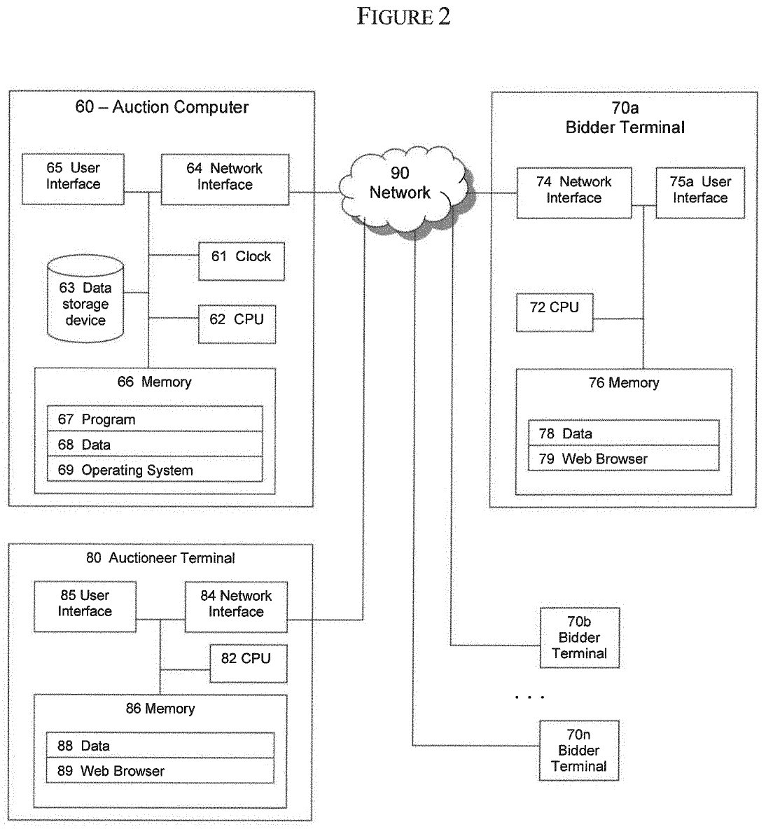

FIG. 2 is another graphical depiction of an exemplary computer system in accordance with an embodiment of the present invention. The auction system of FIG. 2 includes an auction computer 60 (sometimes also referred to as a Bidding Information Processor or BIP), a plurality of user systems 70a, 70b and so on (sometimes also referred to as Bidder Terminal or BT), each user system 70a-n representing an individual bidder, and a user system 80 (sometimes also referred to as an Auctioneer Terminal or AT). The systems 60, 70a-n, and 80 communicate over a network 90. The network represents any system capable of providing the necessary communication to/from BIP, BT, and AT. The network may be a local or wide area network such as, for example, Ethernet, token ring, the Internet, the World Wide Web, the information superhighway, an intranet or a virtual private network, or alternatively a telephone system, either private or public, a facsimile system, an electronic mail system, or a wireless communications system. Each of the systems 60, 70a-n, and 80 may include a typical user interface 65, 75a-n, 85 for input/output which may include a conventional keyboard, display, and other input/output devices. Within each of the systems, the user interface (65, 75a-n, 85) is coupled to a network interface (64, 74a-n, 84), which in turn communicates via the network 90. Both the user interface and network interface connect, at each system, to a CPU (62, 72a-n, 82). Each system includes a memory (66, 76a-n, 86). The BIP 60 also includes a clock 61 and a data storage device 63, which will ordinarily contain a database. (However, in some embodiments the database might instead be stored in memory 66.) The memory 66 of the BIP 60 can further be broken down into a program 67, data 68 and an operating system 69. The memory (76a-n, 86) of the BTs 70a-n and the AT 80 may include a web browser (for example, Internet Explorer, Mozilla Firefox, Safari or Chrome) (79, 89) or other general-purpose software, but not necessarily any computer program specific to the auction process. In each system the CPU (62, 72a-n, 82) represents a source of intelligence when executing instructions from the memory (66, 76a-n, 86) so that appropriate input/output operations via the user interface and the network interface take place as is conventional in the art. The particular steps used in implementing the inventive auction system and method are described in more detail below. In one embodiment, each of the user systems is a personal computer or workstation.

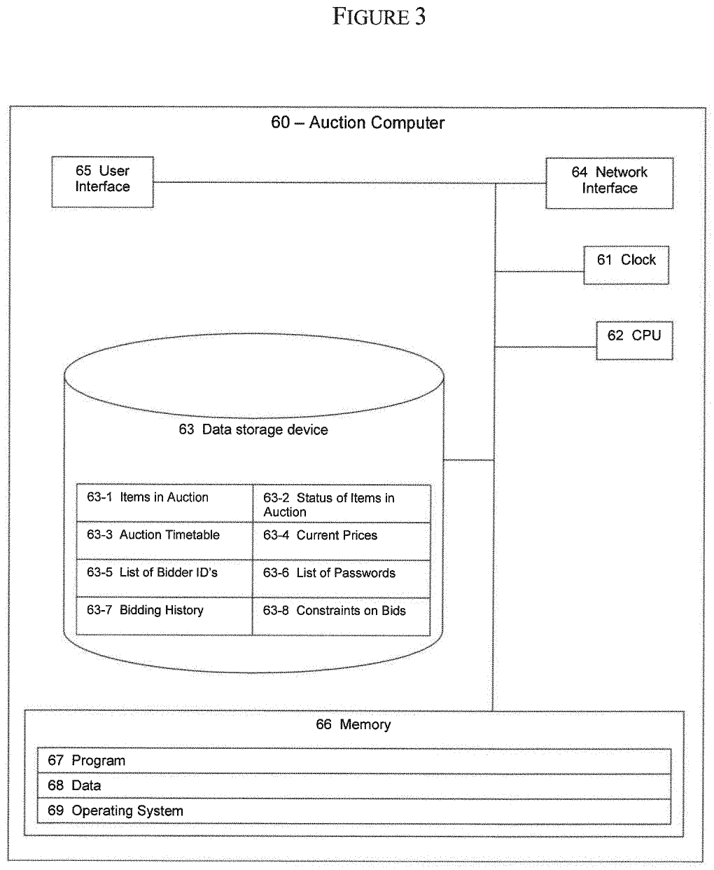

FIG. 3 is a more detailed illustration of an exemplary BIP 60 showing details of the database. As discussed for FIG. 2, the database is ordinarily stored on a data storage device 63, although in some embodiments it might instead be stored in memory 66. As depicted in FIG. 3, the database includes provision for creating, storing, and retrieving records representing Items in the Auction 63-1, Status of the Items in the Auction 63-2, Auction Timetable 63-3, Current Price(s) 63-4, List of Bidder ID's 63-5, List of Passwords 63-6, Bidding History 63-7, and Constraints on Bids 63-8. The particular set of data required for any particular auction and the format of that datum or data (such as scalar, vector, list, etc.) is more particularly specified by the detailed description of that auction.

In many of the most useful embodiments, a computer readable medium such as the data storage device 63 and/or memory 66 stores a sequence of instructions which, when executed, implements a program for conducting the auction.

### Bidders, Items, and Types

There are n bidders (n≥1), often superscripted or subscripted by i(i=1, . . . . , n), participating in the auction. Let Ω denote the set of items that are included in the auction. The aim of the auction is to allocate, among the bidders, the elements of the set Ω.

Some of the most useful embodiments of the present invention apply in situations where some of the elements of the set Ω are identical or close substitutes to one another. A type of item comprises a (nonempty) subset of Ω, such that any two items within the same type are identical items or close substitutes. Meanwhile, types are defined so that any two items of different types exhibit significant differences in time, location or any other product characteristics. There may be a single unit or multiple units within a given type. Whenever we state that there are “unique goods,” we are referring to the case where there is only a single unit within every type.

In what follows, we will assume that there are m types of items (m≥1) included in the auction. Whenever we state that there is a “plurality of types of items,” we are referring to the case where m≥2. There are often said to be “heterogeneous” goods or “dissimilar items” in the case where m≥2. Whenever we state that there are “homogeneous” goods or “identical objects,” we are referring to the case where m=1. Whenever we state that there is a “plurality of bidders,” we are referring to the case where the number, n, of bidders participating in the auction satisfies n≥2.

### Packages and Packaoe Bids

In many preferred embodiments of the present invention, bids comprise pairs, (S, P), where S⊂Ω is a package, i.e., a subset of the set of all items being auctioned, and P is a price at which the bidder is offering to transact for the entire package S. Stated differently, a bid comprises a package of items and an associated price for the entire package. Such a bid comprising a pair, (S, P), is defined to be a package bid.

In the event that the elements of the set Ω have been classified into types, a package can be identified by a quantity vector (Q₁, . . . , Qₘ) of each of the m (m≥1) types of items. A package bid for bidder i would then comprise a quantity vector (Q₁ⁱ, . . . , Qₘⁱ) and a price, P, at which bidder i is offering to transact for the entire set identified by the quantity vector. Such a bid (Q₁ⁱ, . . . , Qₘⁱ; P) is defined to be a packaoe bid in the “type” notation.

### Clock Auctions

A clock auction is an auction process that proceeds as follows. First, a price vector indicating the price of each type of item is transmitted to bidders (i.e., bidder terminals). Second, a bidder responds with a quantity vector indicating the quantity of each respective type of item that the bidder wishes to transact at the current price vector. A computer determines whether the auction should continue or terminate, and if the decision is to continue, the price vector is adjusted and the process is repeated.

More precisely, consider a situation where the items included in the auction have been classified into types. The current price vector comprises a vector, (P₁, . . . , Pₘ), whose components represent the prices (per unit) for the m respective types of items. Each bidder i selects one or more package bids by selecting a quantity vector, (Q₁ⁱ, . . . , Qₘⁱ), whose components indicate the quantities that bidder i is willing to buy (in the case of an auction to sell) or to sell (in the case of an auction to buy) at the current price vector for the m respective types of items. The quantity vector thus identifies the package of items that bidder i desires to transact. The associated price, Pⁱ , at which bidder i is offering to buy or sell the package is implied by:

Pⁱ=Σₖ₌₁^{m}pₖQₖⁱ,

A bid of bidder i in a clock auction comprises a quantity vector, (Q₁ⁱ, . . . , Qₘⁱ), together with the implied price, Pⁱ, calculated at the current price vector. Depending on the particular embodiment of the present invention, a bidder may be permitted to select a single bid at each current price vector, or a bidder may be permitted to select more than one bid at each current price vector.

The bidding history comprises the current price vector and the bids associated with the current time and all earlier times in the current auction.

The available Quantities are specified for each type of item. The available quantity for type k of item will be denoted Q̅ₖ, and this refers, in the case of an auction to sell, to the overall quantity of items of type k to be offered for sale in the auction or, in the case of an auction to buy (i.e., a procurement auction or a “reverse auction”), to the overall quantity of items of type k to be bought in the auction. The vector of available quantities for all types will be denoted (Q̅₁, . . . , Q̅ₘ). Optionally, the available quantities may be allowed to depend on the prices, or otherwise be contingent on the progress of the auction.

With this terminology defined, a clock auction is a dynamic auction procedure whereby: the current price vector is announced to bidders; the bidders each respond with quantity vectors indicating their bids; the auctioneer determines whether the auction should continue based on the bidding history and the available quantities; the auctioneer updates the current price vector based on the bidding history and the available quantities, and the process repeats, if it is determined that the auction should continue; and the auctioneer allocates the items among the bidders and assesses payments among the bidders based on the bidding history and the available quantities, if it is determined that the auction should not continue.

Observe that a “clock auction” differs from a standard ascending-bid electronic auction in the following important sense. In standard ascending-bid electronic auctions—such as in the Federal Communications Commission auctions for radio communications spectrum or in eBay auctions—the bidders name prices (and. perhaps also, quantities) that they propose to pay for the items being auctioned, in an iterative process. In a clock auction, the auctioneer sets the pace for price increases, and bidders respond only with quantity vectors—the associated payments being implied by the current price vector.

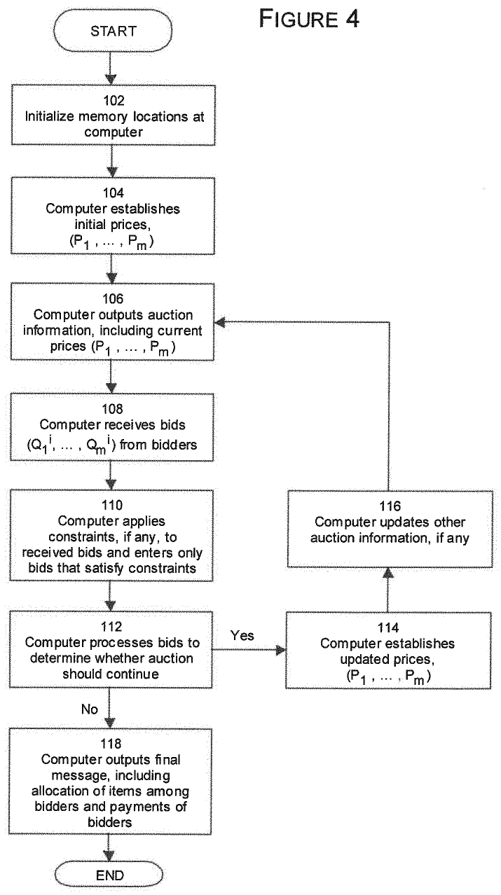

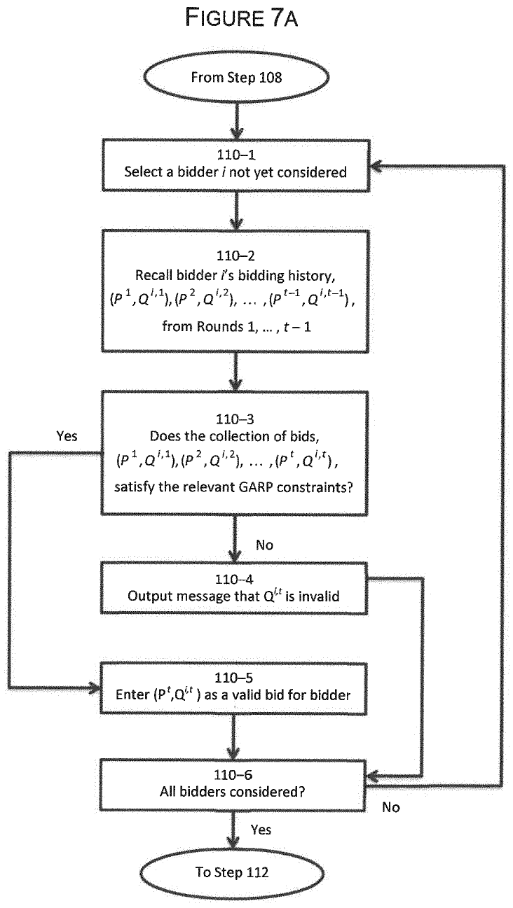

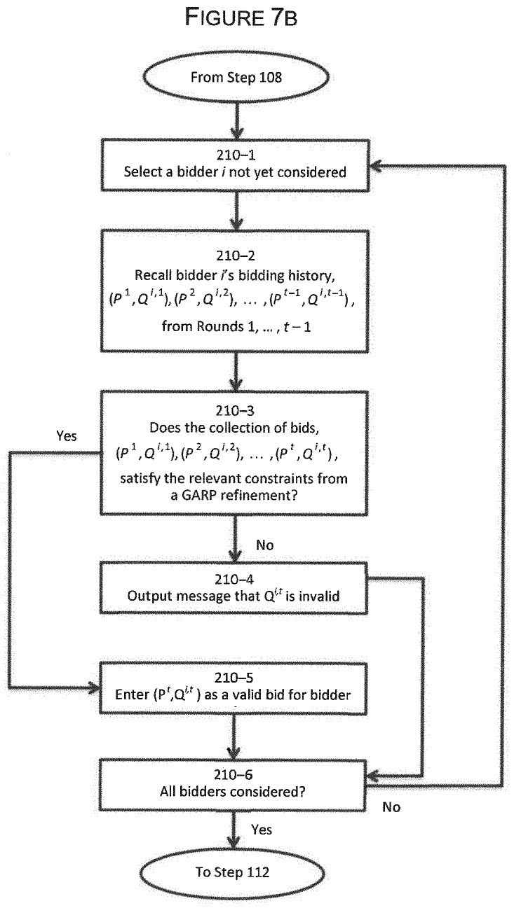

FIG. 4 is a flow diagram of a clock auction in accordance with one embodiment of the present invention. The process starts with step 102, in which memory locations of a computer are initialized. In one preferred embodiment, the appropriate memory locations of the bidding information processor (auction computer) are initialized with information such as the types of items in the auction, the available quantity of each type of item in the auction, an initial price parameter, an auction timetable, a list of bidder ID's, and a list of passwords. In step 104, a computer establishes the initial prices (P₁, . . . , Pₘ). The process proceeds to step 106, in which a computer outputs auction information, including the current price vector (P₁, . . . , Pₘ). In one preferred embodiment, the bidding information processor outputs the auction information through its network interface and transmits it via the network. The bidder terminals then receive the auction information through their network interfaces and display the information to bidders through their user interfaces. In step 108, a computer receives bids (Q₁ⁱ, . . . , Qₘⁱ) from bidders. In one preferred embodiment, a bidder inputs his bids through the user interface of the bidder terminal, which then outputs the auction information through its network interface and transmits it via the network. The bidding information processor then receives the bids through its network interface for use in the next step. In step 110, a computer applies constraints, if any, to the received bids, and enters only those bids that satisfy said constraints. Two versions of this process are illustrated in greater detail, in FIGS. 7a and 7b. In some embodiments, the constraints are applied at the bidding information processor, although they may also easily be applied at the bidder terminals. Moreover, in some preferred embodiments, the constraints are applied in real time, during the bidding rounds, as opposed to after the bidding rounds. That is, bidders may be informed in real time by their bidding interfaces that their new bids would violate the constraints and that they need to submit different new bids. In step 112, a computer processes the received bids and determines whether the auction should continue. In some preferred embodiments, this determination occurs at the bidding information processor.

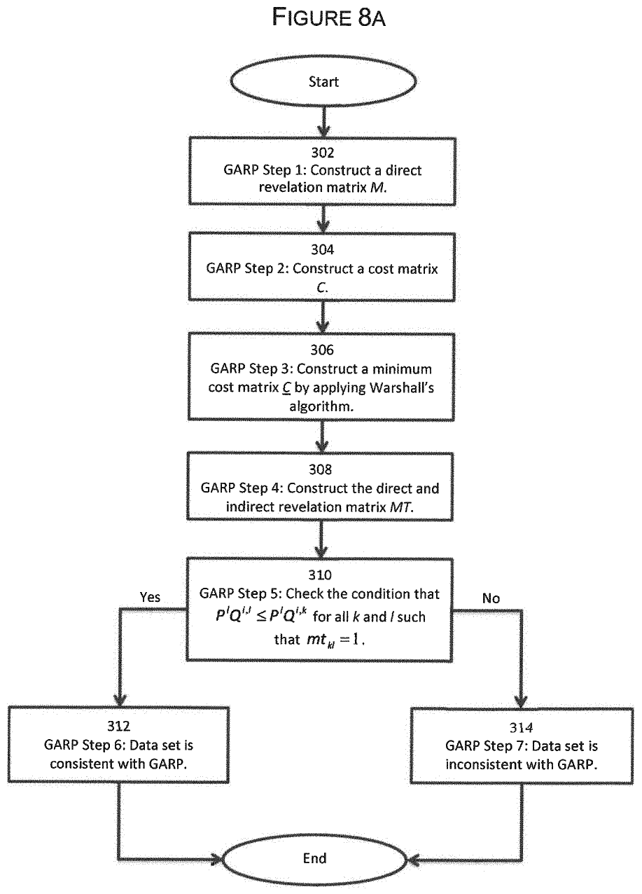

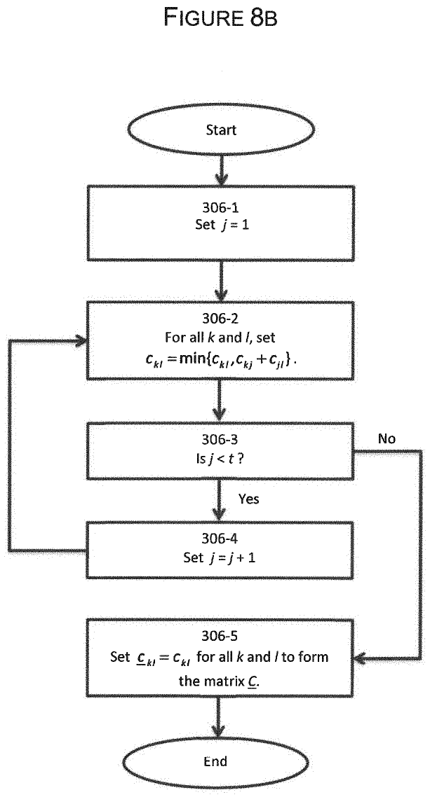

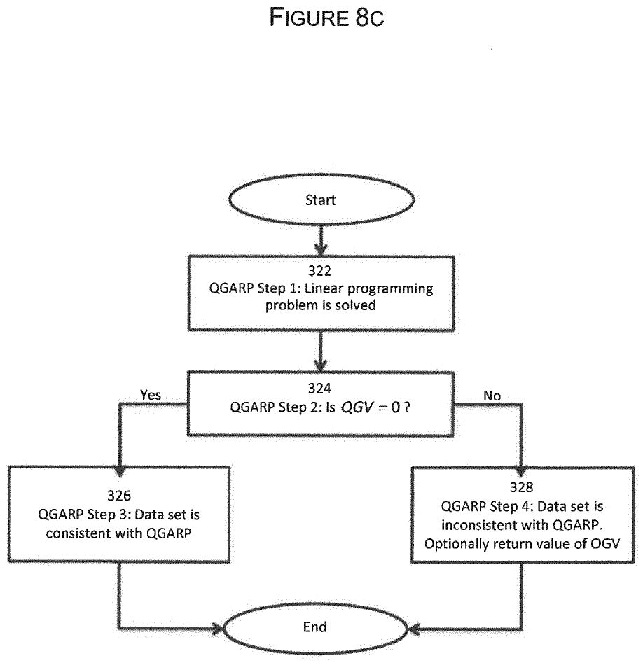

If the auction should continue, the process goes to step 114, in which a computer establishes an updated price vector (P₁, . . . , Pₘ). Then, at step 116, a computer updates other auction information, if any. In a preferred embodiment, the updated information includes the bidders' eligibility data, which is updated as will be shown in FIG. 8. In a preferred embodiment, the bidding information processor also automatically generates a suggested revised price vector, outputs the suggested revised price vector through its network interface, and transmits it via the network. The auctioneer terminal then receives the suggested revised price vector through its network interface and displays it to the auctioneer through its user interface. The auctioneer either approves or modifies the revised price vector through the user interface of the auctioneer terminal, which then outputs the revised price vector through its network interface and transmits it via the network. The bidding information processor then receives the revised price vector through its network interface for use in subsequent steps. The process then loops to step 106.

if the auction should not continue, the process goes to step 118, in which a computer outputs a final message, including the allocation of items among bidders and the payments of the bidders. In one preferred embodiment, the bidding information processor takes the allocation of items among bidders to be their final bids and takes the payment of each bidder i to be the dot product of the final price vector and bidder is final quantity vector:

(P₁, . . . , Pₘ)·(Q₁ⁱ, . . . , Qₘⁱ).

The bidding information processor outputs the allocation and payment outcome through its network interface and transmits it via the network. The bidder terminals and auctioneer terminal then receive the allocation and payment outcome through their network interfaces and display the information to bidders and the auctioneer through their user interfaces. The process then ends.

### Combinatorial Clock Auctions

A combinatorial clock auction is an auction for at least two items that includes two phases of auction: an earlier phase, in which bidders participate in a dynamic auction; and a later phase, in which bidders participate in a package auction. One exemplary combinatorial clock auction (which is a preferred embodiment of the present invention) comprises an earlier phase in which bidders participate in a clock auction and a later phase in which bidders participate in a sealed-bid package auction.

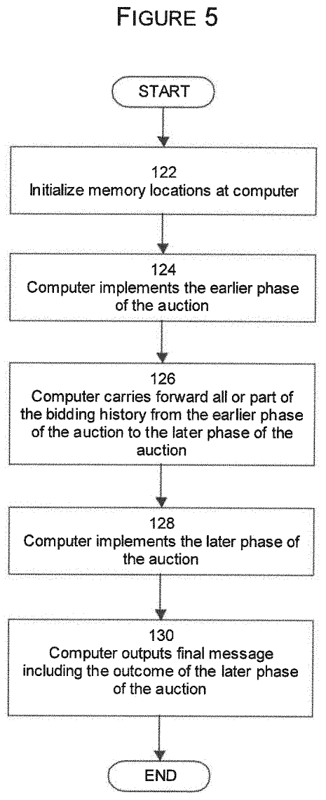

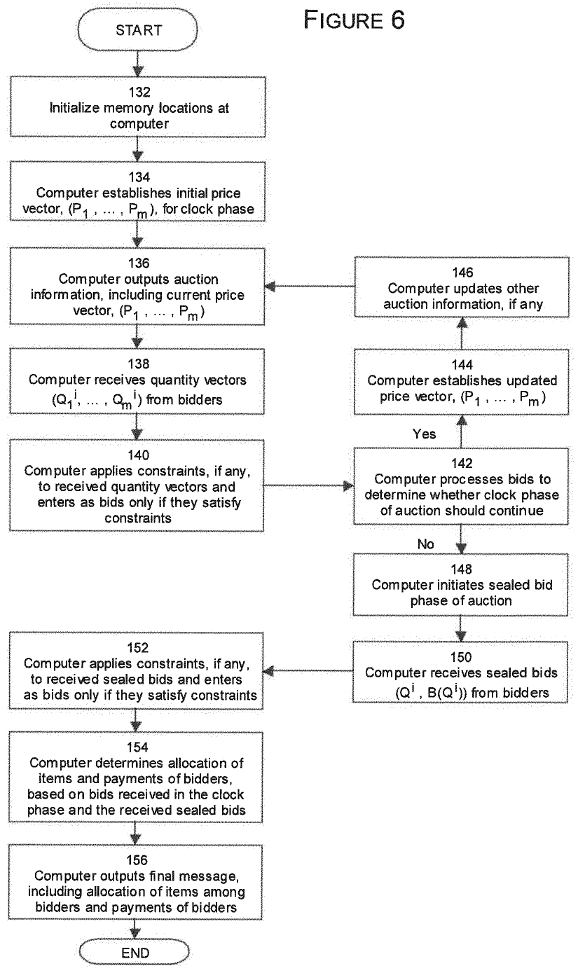

FIG. 5 is a diagram depicting an exemplary combinatorial clock auction. The process starts with step 122, in which memory locations of a computer are initialized. In one preferred embodiment, the appropriate memory locations of the bidding information processor (auction computer) are initialized with information such as the types of items in the auction, the available quantity of each type of item in the auction, an initial price parameter, an auction timetable, a list of bidder ID's, and a list of passwords. In step 124, a computer implements the earlier phase of the auction, which is often a dynamic auction. In one preferred embodiment, the earlier phase of the auction is a clock auction, as shown in greater detail in FIG. 6, below. After the earlier phase of the auction concludes, a computer proceeds to step 126, in which it carries forward all or part of the bidding history from the earlier phase of the auction to the later phase of the auction. In step 128, a computer implements the later phase of the auction, which is a package auction different from the earlier phase of the auction. In one preferred embodiment, the later phase of the auction is a sealed-bid package auction, as shown in greater detail in FIG. 6, below. After the later phase of the auction concludes, a computer proceeds to step 130, in which a computer outputs a final message that includes the outcome of the later phase of the auction. In many preferred embodiments, the outcome of the later phase of the auction also serves as the outcome of the overall combinatorial clock auction. The process then concludes.

FIG. 6 is a flow diagram of a preferred embodiment of the present invention, in which there are two phases to the auction: a clock auction phase; followed by a sealed-bid package auction phase. The process starts with step 132, in which memory locations of a computer are initialized. In one preferred embodiment, the appropriate memory locations of the bidding information processor (auction computer) are initialized with information such as the types of items in the auction, the available quantity of each type of item in the auction, an initial price parameter, an auction timetable, a list of bidder ID's, and a list of passwords. In step 134, a computer establishes the initial price vector (P₁, . . . , Pₘ). The process proceeds to step 136, in which a computer outputs auction information, including the current price vector (P₁, . . . , Pₘ). In one preferred embodiment, the bidding information processor outputs the auction information through its network interface and transmits it via the network. The bidder terminals then receive the auction information through their network interfaces and display the information to bidders through their user interfaces. In step 138, a computer receives quantity vectors (Q₁ⁱ, . . . , Qₘⁱ) from bidders. In one preferred embodiment, a bidder inputs his bids through the user interface of the bidder terminal, which then outputs the auction information through its network interface and transmits it via the network. The bidding information processor then receives the bids through its network interface for use in the next step. In step 140, a computer applies constraints, if any, to the received quantity vectors, and enters as bids only those that satisfy said constraints. Examples of this process are illustrated in greater detail in FIGS. 7a and 7b. (FIGS. 7a and 7b, as literally drawn, show the application of constraints to bids in the clock auction of FIG. 4. However, if all references to Steps 108, 110 and 112 are replaced by references to Steps 138, 140 and 142, respectively, then FIGS. 7a and 7b also show the application of constraints to bids in the clock auction phase of the combinatorial clock auction of FIG. 6.) In one preferred embodiment, the constraints are applied at the bidding information processor, although they may also easily be applied at the bidder terminals. In step 142, a computer processes the entered bids and determines whether the clock auction phase of the auction should continue. In some preferred embodiments, this determination occurs at the bidding information processor.

If the clock phase of the auction should continue, the process goes to step 144, in which a computer establishes an updated price vector (P₁, . . . , Pₘ). Then, at step 146, a computer updates other auction information, if any. In a preferred embodiment, the updated information includes the bidders' eligibility data, which is updated as will be shown in FIG. 8. In a preferred embodiment, the bidding information processor automatically generates a suggested revised price vector, outputs the suggested revised price vector through its network interface, and transmits it via the network. The auctioneer terminal then receives the suggested revised price vector through its network interface and displays it to the auctioneer through its user interface. The auctioneer either approves or modifies the revised price vector through the user interface of the auctioneer terminal, which then outputs the revised price vector through its network interface and transmits it via the network. The bidding information processor then receives the revised price vector through its network interface for use in subsequent steps. The process then loops to step 136.

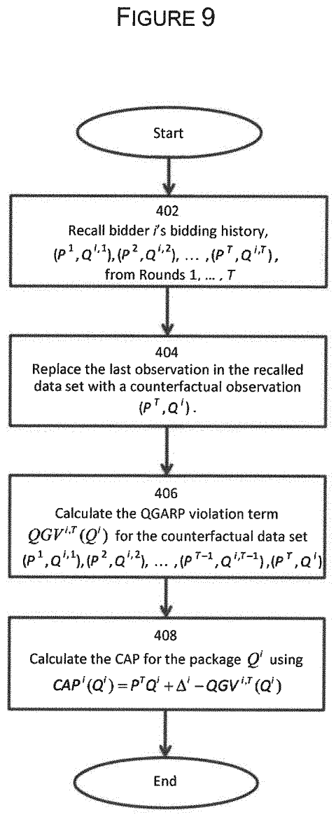

If the clock phase of the auction should not continue, the process goes to step 148, in which a computer initiates a sealed bid phase of the auction. Then, at step 150, a computer receives sealed bids (Qⁱ, B(Qⁱ)) from bidders. The pair (Qⁱ, B(Qⁱ)) is a package bid. Note that Qⁱ=(Q₁ⁱ, . . . , Qₘⁱ) indicates quantities of each of them respective types of items—thus, it identifies the package of items that bidder i desires to transact. B(Qⁱ) is an all-or-nothing price at which bidder i is offering to transact for the entire package Qⁱ. In step 152, a computer applies constraints, if any, to the received sealed bids, and enters only those sealed bids that satisfy said constraints. This process is illustrated in greater detail in FIG. 9. In one preferred embodiment, the constraints are applied at the bidding information processor, although they may also easily be applied at the bidder terminals. Following the entering of the sealed bids, the process goes to step 154, in which a computer determines an allocation of items and payments of bidders, based on bids received in the clock phase of the auction and on the received sealed package bids, In some preferred embodiments, this determination occurs at the bidding information processor. In some embodiments, the determination may be based only on the received sealed bids (although the bids received in the clock phase could still have the effect of constraining the sealed bids in step 152). In step 156, a computer outputs a final message, which includes the allocation and payment outcome, through its network interface and transmits it via the network. The bidder terminals and auctioneer terminal then receive the allocation and payment outcome through their network interfaces and display the information to bidders and the auctioneer through their user interfaces. The process then ends.

### Preliminaries in Relation to Revealed Preference

Before describing the inventive activity rules, it is helpful to review what is known in microeconomics as “revealed preference,” as applied to the environment of the auction.

Suppose that there are m types of items (1, . . . , m) being offered, and let s and t be two times (s<t) at which prices are quoted to an economic agent, who we will call “bidder i.” At each time, bidder i is required to make a purchase decision. Let price vector P^{s}≡P₁^{s}, . . . Pₘ^{s}) denote the prices (per unit) for the respective types of items at time s, and let P^{t}≡(P₁^{t}, . . . , Pₘ^{t}) denote the prices (per unit) for the respective types of items at time t. Further, let quantity vector Q^{i,s}≡(Q₁^{i,s}, . . . , Qₘ^{i,s}) denote the purchase decision (a choice of package) made by bidder i at time s, and let Q^{i,t}≡(Q₁^{i,t}, . . . , Qₘ^{i,t}) denote the purchase decision made by bidder i at time t.

The most basic version of revealed preference is developed as follows. Suppose that bidder i purchased Q^{i,r} at time r and that P^{r}Q^{i,r}≥P^{r}Q^{i,s}. Given that Q^{i,s} could have been bought for the same or less money than Q^{i,r}, but Q^{i,r} is the package that was selected, we say that Q^{i,r} is directly revealed preferred to Q^{i,s}. The Weak Axiom of Revealed Preference (WARP) states that, if Q^{i,r} is directly revealed preferred to Q^{i,s}, then it must not also be the case that Q^{i,s} is directly revealed preferred to Q^{i,r}. In short, we have:

(WARP) P^{r}Q^{i,r}≥P^{r}Q^{i,s}→P^{s}Q^{i,s}<P^{s}Q^{i,r}.

A second (and stronger) version of revealed preference is developed as follows. Suppose that bidder i purchased Q^{i,1} when quoted the price vector P¹, bidder i purchased Q^{i,2} when quoted the price vector P², . . . , and bidder i purchased Q^{i,t} when quoted the price vector P^{t}. Then package Q^{i,r} is said to be revealed preferred to package Q^{i,s} if there is a sequence j, k, . . . , l such that P^{r}·Q^{i,r}≥P^{r}·Q^{i,j}, P^{j}·Q^{i,j}≥P^{j}·Q^{i,k}, . . . , P^{l}·Q^{i,l}≥P^{l}·Q^{i,s}.

The data (P¹, Q^{i,1}), (P², Q^{i,2}), . . . , (Pⁱ, Q^{i,t}) are said to satisfy the Generalized Axiom of Revealed Preference (GARP) if the following implication holds:

(GARP) Package Q^{i,r} is revealed preferred to package Q^{i,s}→P^{s}·Q^{i,s}≥P^{s}·Q^{i,r}.

Intuitively, GARP requires that there is “cyclical consistency” among purchase decisions: if package Q^{i,r} is revealed to be preferred to package Q^{i,s} through a sequence of decisions, then package Q^{i,s} cannot be revealed to be strictly preferred to the original package Q^{i,r}.

For completeness, the data (P^{l}, Q^{i,l}), (P², Q^{i,2}), . . . , (P^{l}, Q^{i,r}) are said to satisfy the Strong Axiom of Revealed Preference (SARP) if the following implication holds:

(SARP) Package Q^{i,r} is revealed preferred to package Q^{i,s}→P^{s}·Q^{i,s}<P^{s}·Q^{i,r}.

It turns out that SARP may be an excessively strong condition and that the most preferred embodiments of the present invention operationalize GARP. Nevertheless, it is also possible to operationalize SARP in the invention next described.

Suppose, in addition, that bidder i has a “quasilinear” utility function, meaning that the payoff to bidder i from winning a package Qⁱ at a price of Pⁱ is given by the functional form vⁱ(Qⁱ)-Pⁱ. Let us make this assumption of quasilinearity and consistent valuations for each package of items, in particular, a consistent valuation vⁱ(Q^{i,r}) for the package Q^{i,r}, and a consistent valuation vⁱ(Q^{i,s}) for the package Q^{i,s}. Observe that bidder i had the choice whether to purchase Q^{i,r} or Q^{i,s} at time r, but bidder i selected Q^{i,r}. This implies that the following first inequality holds:

vⁱ(Q^{i,r})−P^{r}·Q^{i,r}≥vⁱ(Q^{i,s})−P^{r}·Q^{i,s}.

Also observe that bidder i had the choice whether to purchase Q^{i,r} or Q^{i,s} at time s, but bidder i selected Q^{i,s}. This implies that the following second inequality holds:

vᵢ(Q^{i,s})−P^{s}·Q^{i,s}≥vⁱ(Q^{i,r})−P^{s}·Q^{i,r}.

Adding the above first inequality and second inequality produces a further inequality that we will refer to as the Quasilinear Weak Axiom of Revealed Preference (QWARP). It states that the price vectors and the quantity vectors selected by bidder i must together satisfy the following inequality:

(QWARP) (P^{r}−P^{s})·(Q^{i,r}−Q^{i,s})≥0, for all r≠s.

Intuitively, QWARP states that an economic agent expresses consistent valuations for the items only if the agent switches from demanding a first package to a second package when the second package becomes relatively less expensive than the first package.

A second (and stronger) version of quasilinear revealed preference can also be developed, by considering the implications of revealed preference through chains of comparison. The data (P¹, Q^{i,1}), (P², Q^{i,2}), . . , (P^{t}, Q^{i,t}) are said to satisfy the Quasilinear Generalized Axiom of Revealed Preference (QGARP) if the following implication holds:

(QGARP) For every sequence {h, j, k, . . . , l} taken from {1, 2, . . . t}: P^{h}(Q^{i,h}−Q^{i,j})+Pⱼ(Q^{i,j}−Q^{i,k})+ . . . +P^{l}(Q^{i,j}−Q^{i,h})≥0.

Note that QGARP is a stronger condition than GARP: any data that satisfies QGARP also satisfies GARP, but the converse statement is not true. We shall refer to any condition that is stronger than GARP as a GARP refinement. Observe that SARP is also a GARP refinement.

The reason why GARP (and its refinements) will be the most appropriate conditions is because of a classic result, known as Afriat's Theorem, in the microeconomics literature:
Afriat's Theorem (1967): A finite set of data is consistent with utility maximization if and only if the data set satisfies GARP.
   Despite the fact that Afriat's Theorem has been well known in the art for more than 40 years, nobody has thought until now to operationalize GARP (and its refinements) into an auction system or method.

### QWARP-Based Activity Rules

The prior art includes activity rules for auctions based on QWARP (see, for example, published Application 20040054551). However, QWARP-based activity rules suffer from two severe limitations. First, the constraints placed on bidders are somewhat too weak. Second, a bidder may submit bids that create a “dead end” to any further bidding. For example, in the following scenario, if the bidder who is constrained by QWARP submits the indicated bids in Rounds 1-3, then the bidder's only allowable bid in Round 4 is (0, 0, 0), i.e. the bidder is forced to drop out of the auction. The second limitation may be viewed as a fatal flaw. Consider:

| Round | Price vector | Bidder's demand |
|---|---|---|
| 1 | P¹ = (1, 1, 1) | Q^{i, 1} = (1, 0, 0) |
| 2 | P² = (1, 1, 4) | Q^{i, 2} = (0, 1, 0) |
| 3 | P³ = (4, 1, 4) | Q^{i, 3} = (0, 0, 1) |
| 4 | P⁴ = (4, 3, 5) | Q^{i, 4} = ??? |

If bidder i's bids are constrained by QWARP, observe: (1) bidder i cannot bid on the first product in Round 4, as he bid on the second product in Round 2, and the first product has now become relatively more expensive than the second product in Round 4; (2) bidder i cannot bid on the second product in Round 4, as he bid on the third product in Round 3, and the second product has now become relatively more expensive than the third product; and (3) bidder i cannot bid on the third product in Round 4, as he bid on the first product in Round 1, and the third product has now become relatively more expensive than the first product in Round 4. As a consequence, the only remaining allowable bid for bidder i is (0, 0, 0).

### Activity Rules Based on GARP or Refinements of GARP

Some preferred embodiments of this invention include the enforcement of new activity rules, based on GARP (or refinements of GARP). The new activity rules improve upon a pure eligibility-point approach, as well as upon a pure QWARP-based approach or a hybrid approach combining eligibility points and QWARP.

Definition: A GARP-based activity rule is a requirement that, given a history of prior bids, (P¹, Q^{i,1}), (P², Q^{i,2}), . . . , (Pⁱ⁻¹, Q^{i,t-1}), the bid (P^{t}, Q^{i,t}) is allowable only if the resulting collection of bids, (P¹, Q^{i,1}), (P², Q^{i,2}), . . . , (P^{t-1}, Q^{i,t-1}), (Pⁱ, Q^{i,t}), satisfies a specified subset of the set of all GARP constraints. The full GARP activity rule is the requirement that, given a history of prior bids (P¹, Q^{i,1}), (P², Q^{i,2}), . . . , (P^{t-1}, Q^{i,t-1}), the bid (P^{t}, Q^{i,t}) is allowable only if the resulting collection of bids, (P¹, Q^{i,1}), (P², Q^{i,2}), . . . , (P^{t-1}, Q^{i,t-1}), (Pⁱ, Q^{i,t}), satisfies GARP in full.

A similar definition can be written for any refinement of GARP:

Definition: A GARP-refinement-based activity rule is a requirement that, given a history of prior bids, (P¹, Q^{i,1}), (P², Q^{i,2}), . . . , (P^{t-1}, Q^{i,t-1}), the bid (P^{t}, Q^{i,t}) is allowable only if the resulting collection of bids, (P¹, Q^{i,1}), (P², Q^{i,2}), . . . , (P^{t-1}, Q^{i,t-1}), (Pⁱ, Q^{i,t}), satisfies a specified subset of the set of the constraints defined by a specified refinement of GARP. The full GARP-refinement activity rule is the requirement that, given a history of prior bids (P¹, Q^{i,1}), (P², Q^{i,2}), . . . , (P^{t-1}, Q^{i,t-1}), the bid (P^{t}, Q^{i,t}) is allowable only if the resulting collection of bids, (P¹, Q^{i,1}), (P², Q^{i,2}), . . . , (P^{t-1}, Q^{i,t-1}), (P^{t}, Q^{i,t}), satisfies the specified refinement of GARP in full. In particular, a QGARP-based activity rule is a requirement that a bid is allowable only if the resulting collection of bids satisfies a specified subset of the QGARP constraints, and the QGARP activity rule is the requirement that a bid is allowable only if the resulting collection of bids satisfies QGARP.

FIG. 7a is a flow diagram of an exemplary subprocess of step 110 of FIG. 4, in which GARP constraints are applied to the bids received in round t of the clock auction, and only bids that satisfy these constraints are entered. (If all references to Steps 108, 110 and 112 are replaced by references to Steps 138, 140 and 142, respectively, then it equally serves as an exemplary subprocess of step 140 of FIG. 6.) The process of FIG. 7a begins with step 110-1, in which a bidder i who has not yet been considered is selected. In step 110-2, bidder i's bidding history, (P¹, Q^{i,1}), (P², Q^{i,2}), . . . , (P^{t-1}, Q^{i,t-1}), ,from Rounds 1, 2, . . . , t−1, is retrieved from memory.

In step 110-3, it is checked whether the data, (P¹, Q^{i,1}), (P², Q^{i,2}), . . . , (P^{l}, Q^{i,l}), formed by combining the current price vector and bidder i's bid, (P^{l}, Q^{i,l}), with the prior bidding history (P¹, Q^{i,1}), (P², Q^{i,2}), . . . , (Pⁱ⁻¹, Q^{i,t-1}), satisfies GARP, i.e., whether:

Package Q^{i,h} is revealed preferred to package Q^{i,s}→P^{s}·Q^{i,s}≥P^{s}·Q^{i,h}.

(In other embodiments, the data, (P¹, Q^{i,1}), (P², Q^{i,2}), . . . , (P¹, Q^{i,l}), is tested against only a subset of the GARP constraints.) If the data, (P¹, Q^{i,1}), (P², Q^{i,2}), . . . , (P¹, Q^{i,l}), satisfies the relevant GARP constraints, the process continues to step 110-5, where the bid is entered as a valid bid, and then continues to step 110-6. However, if the data, (P¹, Q^{i,1}), (P², Q^{i,2}), . . . , (P^{t}, Q^{i,t}), does not satisfy the relevant GARP constraints, the process goes to step 110-4, where a message is outputted that the quantity vector Q^{i,t} is invalid. This quantity vector then is not entered as part of a valid bid. The process then goes to step 110-6, where it is determined whether all bidders have been considered. If not, the process loops back to step 110-1. If all bidders have been considered, the process goes to step 122 of FIG. 4.

FIG. 7b is a flow diagram of another exemplary subprocess of step 110 of FIG. 4, in which the constraints from a GARP refinement are applied to the bids received in round t of the clock auction, and only bids that satisfy these constraints are entered. (If all references to Steps 108, 110 and 112 are replaced by references to Steps 138, 140 and 142, respectively, then it equally serves as an exemplary subprocess of step 140 of FIG. 6.) Note that QGARP is one example of a GARP refinement for which FIG. 7b is applicable—and we will exposit FIG. 7b using QGARP—but any GARP refinement could be utilized here. The process of FIG. 7b begins with step 210-1, in which a bidder i who has not yet been considered is selected. In step 210-2, bidder i's bidding history, (P¹, Q^{i,1}), (P², Q^{i,2}), . . . , (P^{t-1}, Q^{i,t-1}), from Rounds 1, 2, . . . , t−1, is retrieved from memory.

In step 210-3, it is checked whether the data, (P¹m Q^{i,1}), (P², Q^{i,2}), . . . , (P^{t}, Q^{i,l}), formed by combining the current price vector and bidder i's bid, (P^{t}, Q^{i,t}), with the prior bidding history (P¹, Qⁱ¹), (P², Q^{i,2}), . . . , (P^{t-1}, Q^{t,t-1}), satisfies QGARP, i.e., whether:

For every sequence {h, j, k, . . . , l} taken from {1, 2, . . . , t}: Pₕ(Q^{t,h}−Q^{i,j})+P^{j}(Q^{i,j}−Q^{i,k})+ . . . +P^{l}(Q^{i,l}−Q^{i,j})≥0.

(In other embodiments, the data, (P¹, Q^{i,1}), (P², Q^{i,2}), . . . , (Pⁱ, Q^{i,t}), is tested against only a subset of the QGARP constraints.) If the data, (P¹, Q^{i,1}), (P²,Q^{i,2}), . . . , (P^{l}Q^{i,l}), satisfies the relevant QGARP constraints, the process continues to step 210-5, where the bid is entered as a valid bid, and then continues to step 210-6. However, if the data, (P¹, Q^{i,1}), (P², Q^{i,2}), . . . , (P^{t}, Q^{i,t}), does not satisfy the relevant QGARP constraints, the process goes to step 210-4, where a message is outputted that the quantity vector Q^{i,t} is invalid. This quantity vector then is not entered as part of a valid bid. The process then goes to step 210-6, where it is determined whether all bidders have been considered. If not, the process loops back to step 210-1. If all bidders have been considered, the process goes to step 122 of FIG. 4.

### Verifying GARP

One methodology for verifying whether a finite data set is consistent with GARP is known in the art. An efficient way to accomplish this task is to apply Warshall's algorithm (Warshall (1962)). Warshall's algorithm comes from the computer science literature and is intended to solve a problem of minimizing the cost of a path in a graph. Varian (1982a) showed how this algorithm can be utilized to determine whether a given data set is consistent with GARP.

The following is a step-by-step procedure that verifies whether a given data set (P¹, Q^{i,1}), (P², Q^{i,2}), . . . , (P^{t}, Q^{i,t}), is consistent with GARP.
GARP Step 1. Construct a direct revelation matrix M whose elements mₖₗ are given by:

$${m}_{kl} = \{ \begin{matrix}1 & {P}^{l} {Q}^{i , l} \geq {P}^{l} {Q}^{i , k} \\ 0 & otherwise\end{matrix} ∀ k , l ∈ \{ 1 , … , t \} .$$

GARP Step 2. Construct a cost matrix C based on the matrix M from Step 1:

$${c}_{kl} = \{ \begin{matrix}1 & {m}_{kl} = 1 \\ ∞ & {m}_{kl} = 0\end{matrix} ∀ k , l ∈ \{ 1 , … , t \} .$$

GARP Step 3. Calculate a minimum cost matrix C by applying Warshall's algorithm to the cost matrix C from Step 2:
   1. Set j=1.
   2. For all k and l, set cₖₗ=min {cₖₗ, cₖⱼ+cⱼₗ}.
   3. If j<t , let j=j+1 and go to 2. If j=t , set cₖₗ=cₖₗ for all k and l.
GARP Step 4. Construct the direct and indirect revelation matrix MT based on the matrix C from Step 3:

$${mt}_{kl} = \{ \begin{matrix}1 & {\underline{c}}_{kl} < ∞ \\ 0 & otherwise\end{matrix} ∀ k , l ∈ \{ 1 , … , t \}$$

GARP Step 5. Check whether P^{l}Q^{i,l}≥P^{l}Q^{i,k}, for all k and l such that mtₖₗ=1.
GARP Step 6. In the event that the answer to Step 5 is “yes” (i.e., no violations of P^{l}Q^{i,j}≥P^{l}Q^{i,k} are identified, return the result that the data set is consistent with GARP.
GARP Step 7. In the event that the answer to Step 5 is “no” (i.e., there exists a pair of indexes k and l such that mtₖₗ=1 and P^{l}Q^{i,l}>P^{l}Q^{i,k}), return the result that the data set is inconsistent with GARP.

FIG. 8a is a flow diagram of an exemplary subprocess of step 110-3 of FIG. 7a, in which it is checked whether the data, (P¹, Q^{i,1}), (P², Q^{i,2}), . . . , (P^{t}Q^{i,t}), satisfies GARP. The process of FIG. 8a begins with step 302, in which a direct revelation matrix M is constructed. The process then goes to step 304, in which a cost matrix C is constructed from matrix M. The process goes to step 306, in which a minimum cost matrix C is constructed by applying Warshall's algorithm. The process continues to step 308, in which a direct and indirect revelation matrix MT is constructed from the matrix C. The process then goes to step 310, in which it is verified whether P^{l}Q^{i,j}≤P^{l}Q^{i,k} for all for all k and l such that mtₖₗ=1 where mtₖₗ is a k-l element of the matrix MT. If step 310 does not find any violations of the condition, the process goes to step 312, in which the result is returned that the data set is consistent with GARP. If step 310 does find at least one violation of the condition, the process goes to step 314, in which the result is returned that the data set is inconsistent with GARP.

FIG. 8b is a flow diagram of an exemplary subprocess of step 306 of FIG. 8a, in which Warshall's algorithm is applied. The process starts with step 306-1 where the value of index j is initialized at a value of 1. The process then goes to step 306-2, in which for all vertexes k and l, the minimum cost between vertexes k and l is set to a minimum of the current cost between k and l and a cost of path that goes from k to j and then form j to l, i.e., cₖₗ=min {cₖₗ, cₖⱼ+cⱼᵢ} for all k and l. The process then goes to step 306-3, in which it is checked whether the current value of index j is less than t where t is a number of vertexes in a graph. If j<t, the process goes to step 306-4, in which the value of index j is incremented by one, and then the process returns to step 306-2. If j=t, the process goes to step 306-5 where the minimum cost matrix C is formed from the elements of the modified matrix C.

The following are relevant references in relation to verifying GARP:
Warshall, S. (1962), “A Theorem on Boolean Matrices,” Journal of the American Association of Computing Machinery, 9:11-12.
Varian, H. (1982a), “The Nonparametric Approach to Demand Analysis,” Econometrica, 50(4):945-972.
Varian, H. (1982b), “Nonparametric Test of Models of Consumer Behavior,” Review of Economic Studies, 50:99-110.

### Verifing QGARP

Some embodiments of the present invention require checking whether a data set (P¹, Q^{i,1}), (P², Q^{i,2}), . . . , (P^{t}, Q^{i,t}) satisfies QGARP. One embodiment of the present invention is to confirm directly that there exists a set of quasilinear valuations that is consistent with the data. This can be accomplished by verifying that a solution exists for a system of revealed preference constraints. One advantage of the embodiment that will be described is that it also generates the amount of the “QGARP violation”, which may be useful for various purposes.

For purposes where bids are tested sequentially against a GARP-based activity rule, it is sufficient to verify the data set (P¹, Q^{i,1}), (P², Q^{i,2}), . . . , (P^{t}, Q^{i,t}) for consistency with QGARP provided that the data set (P¹, Q^{i,1}), (P², Q^{i,2}), . . . , (P^{t-1}, Q^{i,t-1}) has been already proven to be consistent with QGARP.

The following is a step-by-step procedure that verifies whether a given data set (P¹, Q^{i,1}), (P², Q^{i,2}), . . . , (P^{l}Q^{i,l}) is consistent with QGARP, under the assumption that the data set (P¹, Q^{i,1}), (P², Q^{i,2}), . . . , (Pⁱ⁻¹, Q^{i,t-1}) is consistent with GARP. Note that a data set with a single observation is always consistent with QGARP,
QGARP Step 1. Solve the following linear programming problem:

$$QGV = {min}_{λ , v} λ$$

subject to:
(1) λ≥0
(2) vᵢ≤vₖ+P^{k}(Q^{i,l}−Q^{i,k}) ∀k∈{1, . . . , t−1}
(3) vₗ≤vᵢ+P^{l}(Q^{i,l}−Q^{i,j}+λ ∀l∈{1, . . . , t}
   It can be readily established that this linear programming problem has a solution.
QGARP Step 2. Check whether QGV=0.
QGARP Step 3. In the event that QGV=0, return the result that the data set is consistent with QGARP.
QGARP Step 4. In the event that QGV>0, return the result that the data set is inconsistent with QGARP and, optionally, return QGV as the “QGARP violation”.

The “QGARP violation” term intuitively shows by how much the last observation, (P^{l}, Q^{i,l}), would violate QGARP when added to the data set (P¹, Q^{i,1}), (P², Q^{i,2}), . . . , (P^{t-1}, Q^{i,t-1}).

FIG. 8c is a flow diagram of an exemplary subprocess of step 210-3 of FIG. 7b, in which it is checked whether the data, (P¹, Q^{i,1}), (P², Q^{i,2}), . . . , (Pⁱ, Q^{i,t}), satisfies QGARP. The process of FIG. 8c begins with step 322, in which the linear programming problem of QGARP Step 1 is solved on a computer. This can be done using general-purpose linear programming software, The value of QGV is returned as a part of the solution to the linear programming problem of QGARP Step 1. By construction, such value of QGV is nonnegative. The process then goes to step 324, in which it is checked whether QGV=0. If QGV=0, the process goes to step 326, in which the result is returned that the data set is consistent with QGARP. However, if QGV>0, the process instead goes to 328, in which the result is returned that the data set is inconsistent with QGARP. In some preferred embodiments, the amount of QGV is also returned as the “QGARP violation”.

### Supplementary Caps

We now describe the process for determining the maximum bid amounts allowed for bids in the supplementary stage of a combinatorial clock auctions. For expositional clarity, this description is written with respect to the QGARP activity rule. However, the same steps can be similarly defined and described for any GARP-based activity rule including any other refinements of GARP.

Suppose that a bidder i has the following bidding history for the clock stage that lasted T rounds (P¹, Q^{i,1}), (P², Q^{i,2}), . . . , (P^{T}, Q^{i,T}). The system of supplementary bid caps for all packages is defined only up to a constant. It is convenient to allow bidder i to increase his last clock bid for package Q^{i,T} by any positive amount. Suppose that bidder i's supplementary bid Bⁱ(Q^{i,T}) for the package Q^{i,T} is P^{T}Q^{i,T}+Δⁱ where Δⁱ≥0.

The system of supplementary bid caps is defined as follows:

$${CAP}^{i} ( {Q}^{i} ) = \{ \begin{matrix}{P}^{T} {Q}^{i} + {Δ}^{i} - {QGV}^{i , T} ( {Q}^{i} ) & {Q}^{i} \neq {Q}^{i , T} \\ ∞ & {Q}^{i} = {Q}^{i , T}\end{matrix} ,$$

where the term P^{T}Qⁱ is the clock price of package Qⁱ in round T, Δⁱ is the difference between the clock price of package Q^{i,T} and the supplementary bid for package Q^{i,T}, and QGV^{i,T}(Qⁱ) is the “QGARP violation” term calculated for the package Qⁱ in round T (in other words, the QGARP violation for the counterfactual data set (P¹, Q^{i,1}), (P², Q^{i,2}), . . . , (P^{T-1}, Q^{i,T-1}), (P^{T}, Qⁱ)).

There are several distinct approaches for calculating the maximum bid amount bidder i is permitted to bid for any given package Qⁱ≠Q^{i,T} in the supplementary round, including:
1. “Simple Cap”
   Under this approach, bidder i's bid for any package Qⁱ≠Q^{i,T} is constrained only by the supplementary bid cap for this package, i.e.,

Bⁱ(Qⁱ)≤CAPⁱ(Qⁱ) .
2. “Relative Cap”
   Under this approach, bidder i's bid for any package Qⁱ≠Q^{i,T} is constrained by the supplementary bid cap for this package and by the corresponding revealed preference constraints with respect to clock rounds in which the chosen clock package Q^{i,t} was cheaper than package Qⁱ, i.e.,

Bⁱ(Qⁱ)≤CAPⁱ(Qⁱ),

and

Bⁱ(Qⁱ)≤Bⁱ(Q^{i,t})+P^{t}(Qⁱ=Q^{i,t})∀t∈{1, . . . , T}: P^{t}Qⁱ≥P^{t}Q^{i,t}

where Bⁱ(Q^{i,t}) is the supplementary bid of bidder i for package Q^{i,t}.
3. “Full Cap”
   Under this approach, bidder i's bid for any package Qⁱ≠Q^{i,T} is constrained by the corresponding revealed preference constraints with respect to all clock rounds, i.e.,

Bⁱ(Qⁱ)≤Bⁱ(Q^{i,t})+P^{t}(Qⁱ−Q^{i,t}) ∀t∈{1, . . . ,T},

where Bⁱ(Q^{i,t}) is the supplementary bid of bidder i for package Q^{i,t}. Note that imposing revealed preference constraints with respect to all clock rounds guarantees that bidder i's bid for Qⁱ cannot exceed the supplementary bid cap for the package Qⁱ, i.e., Bⁱ(Qⁱ)≤CAPⁱ(Qⁱ).

While all of these approaches ensure that the bidder cannot violate the supplementary bid cap, they differ significantly in terms of what supplementary bids the bidder needs to make in order to be able to bid at the supplementary bid cap level for any given package. For example, under the “simple cap” approach, the bidder is permitted to bid at the cap level for any given package without revising the bid amounts for any of the clock packages. In contrast, under the “full cap” approach, bidders would likely need to max out all or many clock bids in order to be able to bid at the cap level. The “relative cap” approach strikes a balance between the “simple cap” and the “full cap” approaches as it only requires bid revisions for some of the clock packages. The main advantage of the “relative cap” approach is that the bidder does not need to revise its clock bids for highly valuable packages in order to be able to bid competitively for less valuable packages. This feature is very attractive in scenarios where the bidders are facing budget constraints.

FIG. 9 is a flow diagram of a preferred embodiment of the present invention, in which CAPⁱ (Qⁱ) for any bidder i is computed and in which the maximum bid amounts allowed for bids in the supplementary stage of a combinatorial clock auctions are determined. The process of FIG. 9 begins with step 402, in which the complete bidding history for Rounds 1 to T is recalled. The process proceeds to step 404, in which the observation for the last clock round is replaced with a counterfactual observation that has the same clock price vector P^{T} but a different quantity demand vector Qⁱ. The process proceeds to step 406, in which the counterfactual data set is verified for consistency with QGARP. The verification procedure returns the nonnegative QGARP violation term. Details on the calculation of the QGARP violation are described in FIG. 8c; the QGARP violation is returned by step 328 of FIG. 8c. Then the process proceeds to step 408, in which the supplementary bidding cap is calculated according to the formula CAPⁱ(Qⁱ)=P^{T}Qⁱ+Δⁱ−QGV^{i,T}(Qⁱ).

### Pricing

In most clock auctions and combinatorial clock auctions in the art, bidder i's bid for package Q^{i,s}, when quoted the price vector P^{s}, is simply taken to be the linear product (“dot product”) of P^{s} Q^{i,s}. The notable exception is Ausubel's “clinching” auction (U.S. Pat. No. 6,026,383), in which items of a homogenous good with (weakly) diminishing marginal values are allocated to bidder i at the current clock price whenever the aggregate demand of bidder i's opponents drop below the available supply. If this occurs at time r, then the quoted price to bidder i at times s>r is a discount off P^{s}Q^{i,s}.

Some preferred embodiments of the present invention develop and operationalize a more general reasoning that is applicable to general environments. We ask the question: What is the highest price that bidder i would need to bid to guarantee winning the package Q^{i,t}? This question effectively makes the working assumption that round t will be the final round of the auction—if it is not the final round, then a generally different calculation is made in round t+1. As a general matter, the highest necessary price to assure winning is unlimited. However, if the auction is nearing the point where aggregate demand equals supply—and if bidder i's opponents are constrained, for example, by the QGARP activity rule—then bidder i might be assured of winning, despite bidding a substantial discount below P^{t}Q^{i,t}. We now describe two versions of the relevant calculation.

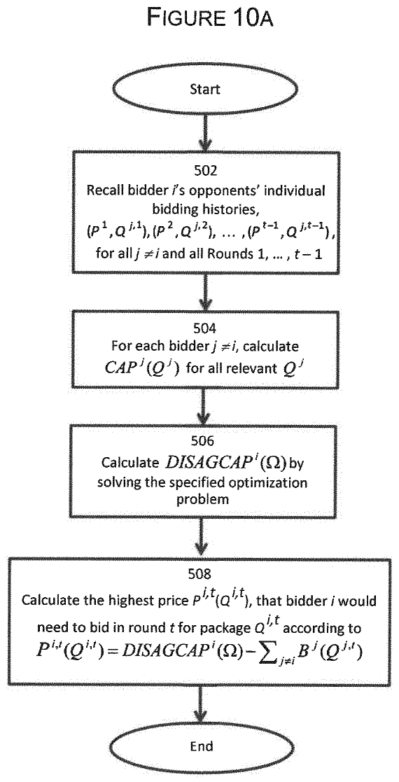

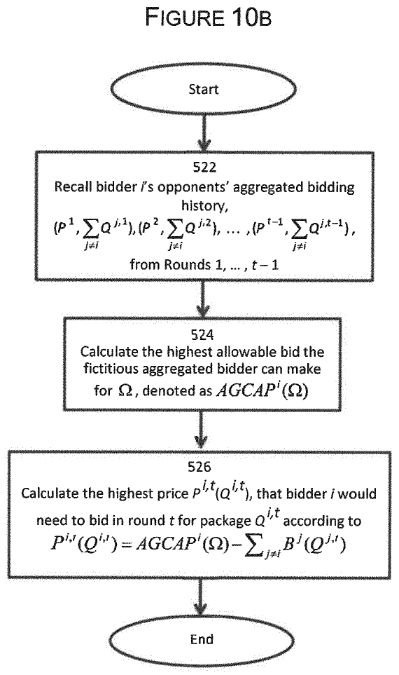

FIG. 10a is a flow diagram of a preferred embodiment of the present invention, in which the highest price that bidder i would need to bid to guarantee winning the package Q^{i,t} is calculated, based on the disaggregated bidding history of bidder i's opponents. The process starts with step 502, in which the disaggregated bidding history of each of bidder i's opponents is recalled from memory. The process then goes to step 504 in which, for each of bidder j≠i and for each relevant package Q^{j}, the cap of bidder j for package Q^{j} is calculated. This highest allowable bid will be denoted by CAP^{j}(Q^{j}). (The calculation of CAPⁱ(Qⁱ) for any bidder i was described in detail in FIG. 9, and was calculated in step 408.) The process then proceeds to step 506 in which the maximum possible bid amount of all of bidder i's opponents for the entire supply Ω is calculated using the disaggregated bidding history. This maximum possible bid amount will be denoted by DISAGCAPⁱ(Ω). It is calculated as the solution to the following optimization problem:

$${DISAGCAP}^{i} ( Ω ) = {max}_{{\{ {Q}^{j} \}}_{j \neq i} s . t . {\sum }_{j \neq i} {Q}^{j} \leq Ω} \{ {\sum }_{j \neq i} {CAP}^{j} ( {Q}^{j} ) \} .$$

(Note that, while step 504 is written as a step that precedes step 506, in other embodiments of the present invention, the two steps are intermixed, in that in calculating the solution to the optimization problem for DISAGCAPⁱ(Ω), the system computes CAP^{j}(Q^{j}) as needed during step 506, rather than in advance of step 506.)

The process then goes to step 508, in which the highest price, P^{i,t} (Q^{i,t}), that bidder i would need to bid to guarantee winning the package Q^{i,t} is calculated. The calculation is:

P^{i,t}(Q^{i,t})=DISAGCAPⁱ(Ω)−Σ_{j≠i}B^{j}(Q^{j,t}).

The intuition is that P^{i,t} (Q^{i,t}) is set at the level such that it, summed together with all of the bids for {Q^{j,t}}_{j≠i}, is exactly equal to the maximum possible bid amount of all of bidder i's opponents for the entire supply Ω. In that event, for any bid by bidder i that exceeds P^{i,t} (Q^{i,t}), the combination of the bids for Q^{i,t} and for {Q^{j,t}}_{j≠i} is guaranteed to exceed the maximum possible bid amount of all of bidder i's opponents for the entire supply Ω.

In other preferred embodiments, the winning bids are calculated somewhat differently and so the formula for P^{i,t} (Q^{i,t}) is slightly different. For example, in some embodiments, the calculation is instead:

P^{i,t}(Q^{i,t})=DISGCAPⁱ(Ω)−Σ_{j≠i}PₜQ^{j,t}.

The process then ends, and the computed value of P^{i,t} (Q^{i,t}) is returned and made available for purposes such as pricing. In some embodiments, the computed value of P^{i,t} (Q^{i,t}) is made available to bidder i so that bidder i is made aware of the effective amount of his bid. However, in embodiments in which the disaggregated bidding data is not disclosed to bidders, the computed value of P^{i,t} (Q^{i,t}) would often not be made available to bidder i, as disclosing it might enable bidder i to infer disaggregated bidding data that was not otherwise being made available to him.

FIG. 10b is a flow diagram of a preferred embodiment of the present invention, in which the highest price that bidder i would need to bid to guarantee winning the package Q^{i,t} is calculated, based on the aggregated bidding history of bidder i's opponents. The process starts with step 522, in which the aggregate bidding history of bidder i's opponents is recalled from memory. (Observe that this could merely be the same operation as step 502, as the aggregate bidding history can be computed from the disaggregated bidding history by aggregating the bids of bidder i's opponents.) The process then goes to step 524 in which the aggregate of all bids is treated, counterfactually, as coming from a single bidder, which we will refer to as the “fictitious aggregated bidder”. Treating the counterfactual bidder as a real bidder, the cap of the fictitious aggregated bidder for the package Ω is calculated, where Ω denotes as usual the entire supply. This highest allowable bid will be denoted by AGCAPⁱ(Ω). The calculation of AGCAPⁱ(Ω) is exactly the same as the calculation of CAPⁱ(Qⁱ) , if the fictitious aggregate bidder were the real bidder i and if the package Ω were the package Qⁱ of bidder i—this calculation was described in detail in FIG. 9, and was calculated in step 408.

The process then goes to step 526, in which the highest price, P^{i,t}(Q^{i,t}), that bidder i would need to bid to guarantee winning the package Q^{i,t} is calculated. The calculation is now:

P^{i,t}(Q^{i,t})=AGCAPⁱ(Ω)−Σ_{j≠i}B^{j}(Q^{j,t}).

The intuition is that P^{i,t} (Q^{i,t}) is set at the level such that it, summed together with all of the bids for {Q^{j,t}}_{j≠t}, is exactly equal to the maximum possible bid amount of all of bidder i's opponents for the entire supply Ω. In that event, for any bid by bidder i that exceeds P^{i,t}(Q^{i,t}), the combination of the bids for Q^{i,t} and for {Q^{j,t}}_{j≠i} is guaranteed to exceed the maximum possible bid amount of all of bidder i's opponents for the entire supply Ω.

In other preferred embodiments, the winning bids are calculated somewhat differently and so the formula for P^{i,t} (Q^{i,t}) is slightly different. For example, in some embodiments, the calculation is instead:

P^{i,t}(Q^{i,t})=AGCAPⁱ(Ω)−Σ_{j≠i}P^{t}Q^{j,t}.

The process then ends, and the computed value of P^{i,t}(Q^{i,t}) is returned and made available for purposes such as pricing. In many of the preferred embodiments, the computed value of P^{i,t}(Q^{i,t}) is made available to bidder i so that bidder i is made aware of the effective amount of his bid. Indeed, in some embodiments, bidder i is told that his legally-binding bid is only for P^{i,t}(Q^{i,t}), rather than for the linear product of P^{t} and Q^{i,t}. Unless the aggregate bidding history is being withheld from bidders—which is uncommon—there is no longer any issue of the computed value of P^{i,t} (Q^{i,t}) enabling bidder i to infer disaggregated bidding data that was not otherwise being made available to him. P^{i,t} (Q^{i,t}) is now based solely on aggregate information.

### Pricing in the Supplementary Stage

With a positive undersell in the final clock round, the supplementary stage is required in order to provide bidders with an opportunity to express values for the lots that were not allocated during the clock stage or any other desired packages.

With the need to carry out the supplementary stage, it is important to incorporate the pricing methodology from the clock stage into the (sealed-bid) supplementary stage.

The preferred approach that will accomplish this task is to perform the standard winner determination and pricing procedures for the sealed-bid auction that takes into account all supplementary and clock bids made by bidders. (To avoid the need to repeat the detailed workings of the combinatorial clock auction, the description in U.S. Pat. No. 7,729,975 is incorporated by reference.) In order to ensure that all bidder pay at least as much as they were quoted during the clock rounds, a set of “pseudo bidders” with “pseudo bids” is added to the winner determination problem.

For any given bidder i, a corresponding pseudo bidder is added to the winner determination problem. A set of pseudo bids for this pseudo bidder i* would include the following bids:
1 . For a clock bid made by bidder i in round t, a pseudo bid is added from the pseudo bidder i* at the price quoted to the bidder i in the round t, i.e., Bⁱ* (Q^{i,t})=P^{i,t}(Q^{i,t}) for all t∈{1, . . . T}.
2. For each subset Qⁱ* of the final clock package of bidder i, a pseudo bid is added from the pseudo bidder i* at the price quoted to bidder i in the final clock round for package Qⁱ*, i.e., Bⁱ*(Qⁱ*)=P^{i,t}(Qⁱ*) for all Qⁱ*⊂Q^{i,T}.
   In order to preserve the integrity of the winner determination problem, an allocation feasibility constraint should be added to the set of constraints that would ensure that both bidder i and the corresponding pseudo bidder i* are not allocated nonzero packages at the same time.

For practical applications, the number of pseudo bids generated according to the above procedure can be prohibitively large. In order to implement this approach, a pseudo bidder i* can be further decomposed into a set of item-specific pseudo bidders exploiting the linearity property of the price quotes from the clock rounds. This is known in the art as a way to implement reserve prices in package auctions with many heterogeneous items.

This pricing approach ensures that bidder i′s payment for its winning package Q^{i,f} composed from the three components in the next equation:

P^{i,f}(Q^{i,f})=P^{T}·(Q^{i,T}∩Q^{i,f})+P^{i,f}(Q^{i,f}\(Q^{i,T}∩Q^{i,f}))−(P^{T}Q^{i,T}−P^{i,T}(Q^{i,T})),

where P^{T}(Q^{i,T}∩Q^{i,f}) is the final clock price of the lots bidder i has won in the final clock round T, P^{i,f}(Q^{i,f}\(Q^{i,R}∩Q^{i,f})) is the price of any extra lots that bidder i might have acquired in the supplementary round (this price component is determined by the supplementary bids bidder i's opponents place in the supplementary round and in general can be as low as reserve price or as high as the final clock price for these extra lots) and P^{T}Q^{i,T}−P^{i,T}(Q^{i,T}) is bidder i's accumulated discount in the final clock round.

### Applicability to Auctions to Buy

For expositional ease, the description herein has focused on auctions to sell. However, many or most of the preferred embodiments of the present invention are equally applicable to auctions to buy (sometimes referred to as “procurement auctions” or “reverse auctions”). First, the embodiments concerned with activity rules are easily applied by a person skilled in the art to reverse auctions. For example, just as the GARP activity rule in an auction to sell is effectively the requirement that the bid (P^{t}, Q^{i,t}) is allowable only if the resulting collection of bids, (P¹, Q^{i,1}), (P², Q^{i,2}), . . . , (P^{t-1}, Q^{i,t-1}), (P^{t}, Q^{i,t}) comes from a buyer consistently expressing its preferences, a GARP activity rule in an auction to buy is effectively the requirement that the bid (P^{t}, Q^{i,t}) is allowable only if the resulting collection of bids, (P¹, Q^{i,1}), (P², Q^{i,2}), . . . , (P^{t}, Q^{i,t}), comes from a seller consistently expressing its preferences.

Second, the embodiments dealing with pricing rules are easily applied by a person skilled in the art to reverse auctions. For example, the pricing rule in an auction to sell asks the question: What is the highest price that bidder i would need to bid to guarantee acquiring the package Q^{i,t} from a seller? Similarly, the pricing rule in an auction to buy asks the question: What is the lowest price that bidder i would need to bid to guarantee selling the package Q^{i,t} to a buyer?

Third, the embodiments concerned with generating iterative first-price auctions are easily applied by a person skilled in the art to reverse auctions. For example, the QGARP activity rule with the pricing rule it justifies effectively enables a “pay-as-bid” combinatorial clock auction to sell goods or services. Similarly, the QGARP activity rule with the pricing rule it justifies effectively enables a “paid-as-bid” combinatorial clock auction to buy goods or services.

In summary, many or most of the preferred embodiments of the present invention are equally applicable to reverse auctions, as well as to forward auctions.

### Auction-Like Optimization Problems and Machine-Generated Bids

In the course of this application, a method and apparatus for implementing auctions of multiple items has been described. The methods and apparatus described allow users to participate in various auctions with a level of attention which varies from continuous, down to the input of information on a single occasion. It should also be apparent that the required level of attention by the “auctioneer” may vary from continuous to essentially zero aside from initiating the auction. Thus, for all intents and purposes, once the basic auction description is selected and the users input desired information, the auction implemented by the invention can be essentially automatic, i.e. devoid of human interaction.

Because in the past auctions have generally been considered to be processes engaged in by persons, the feature of an automatic auction may be, by itself, considered relatively new. There are, however, many other automatic systems which interact in a way that is entirely analogous to an auction and to which the present invention could be applied. Hence, the present invention can be applied to improve the efficiency of computers which are used to operate the automatic systems, by economizing on the collection of informational inputs needed for the system and to speed the computational of optimal resource assignments. At the same time, many optimization problems encountered in the field of operations research have similar mathematical structures to the problem of determining the winners of an auction. Hence, the present invention can be applied to improve the efficiency of computer systems which are used to solve the similar optimization problems, by enabling the computations to be implemented on a system with parallel processing or generally by speeding the computation of solutions.

For example, the air conditioning plant in an office building allocates cool air among individual offices in the building via a dynamic auction. Periodically, the central computer of the air conditioning system serves the role of the “auction computer” in a clock auction, while computers interfaced with the thermostats in each suite of offices serve the role of “bidder terminals.” Each thermostat is programmed to send back bids consisting of a desired quantity of cooled air based on: the current temperature reading of the thermostat, the desired temperature in the office, and the use (if any) to which the office is currently being put. Based on the parameters to which it has been programmed, the central computer of the air conditioning system then provides the results of the auction in its allocation of cooled air among the bidding offices.

In another context, a communications, transportation or energy transmission network faces the technical problem of how to allocate its scarce network resources. The optimization problem in allocating its network resources (e.g., bandwidth, switches, etc.) has a very similar structure to the auction problem. Moreover, clock auctions are again well suited to the problem, since a network provider needing multiple types of network resources is able to iteratively bid on a vector of network resources, always knowing the price of each. Hence, the present invention can be usefully applied to improving the solution to this technical problem.

In another context, computational resources on a distributed computer system can be allocated via a clock auction. Whenever a new job requiring a given quantity of CPU time enters the system, an auction is conducted. Each member of the distributed computer system indicates the quantity of CPU time which it can make available at a given priority level or a given price. In this case, the “auctioneer computer” selects and allocates the resources to be applied to the new job in accordance with some programmed timetable and hence in this fashion provides the results of the auction.

The several examples described herein are exemplary of the invention, whose scope is not limited thereby but rather is indicated in the attached claims.

1. A computer system for determining an allocation of a plurality of items among a plurality of bidders, said items including a plurality of types of items that are related to each other as complements or substitutes, said system comprising:
receiving means for receiving bids, each bid indicating items sought and an associated value;
testing means for testing whether a bidder's bid, when taken together with the bidder's prior bids, reveals a consistent set of objectives;
constraining means for constraining bids so that a bid will only be accepted based upon an activity rule that utilizes the result of the testing means;
first determining means for determining whether to continue accepting bids based upon the received bids; and
second determining means for determining an allocation of the items among the plurality of bidders based upon the received bids and outputting said allocation of the items, after a determination not to continue accepting bids.

2. The system of claim 1 wherein the plurality of items includes at least ten items.

3. The system of claim 2 wherein the testing means tests whether a bidder's bid, when taken together with the bidder's prior bids, satisfies GARP.

4. The system of claim 2 wherein the testing means tests whether a bidder's bid, when taken together with the bidder's prior bids, satisfies QGARP.

5. The system of claim 2 wherein the constraining means constrains bids with a GARP-based activity rule.

6. The system of claim 2 wherein the constraining means constrains bids with a QGARP-based activity rule.

7. The system of claim 2, further comprising a pricing means for calculating one bidder's guaranteed winning value associated with a package of the plurality of types of items and outputting said one bidder's guaranteed winning value, said one bidder's guaranteed winning value based upon the bids of other bidders than said one bidder and an activity rule applied to the other bidders by said constraining means.

8. The system of claim 3, further comprising a pricing means for calculating one bidder's guaranteed winning value associated with a package of the plurality of types of items and outputting said one bidder's guaranteed winning value, said one bidder's guaranteed winning value based upon the bids of other bidders than said one bidder and an activity rule applied to the other bidders by said constraining means,

9. The system of claim 4, further comprising a pricing means for calculating one bidder's guaranteed winning value associated with a package of the plurality of types of items and outputting said one bidder's guaranteed winning value, said one bidder's guaranteed winning value based upon the bids of other bidders than said one bidder and an activity rule applied to the other bidders by said constraining means.

10. The system of claim 5, further comprising a pricing means for calculating one bidder's guaranteed winning value associated with a package of the plurality of types of items and outputting said one bidder's guaranteed winning value, said one bidder's guaranteed winning value based upon the bids of other bidders than said one bidder and an activity rule applied to the other bidders by said constraining means.

11. The system of claim 6, further comprising a pricing means for calculating one bidder's guaranteed winning value associated with a package of the plurality of types of items and outputting said one bidder's guaranteed winning value, said one bidder's guaranteed winning value based upon the bids of other bidders than said one bidder and an activity rule applied to the other bidders by said constraining means.

12. The system of claim 4, further comprising transmitting means for transmitting a price vector indicating a price for each type of item to bidders.

13. The system of claim 6, further comprising transmitting means for transmitting a price vector indicating a price for each type of item to bidders.

14. The system of claim 4 wherein the receiving means receives package bids.

15. The system of claim 6 wherein the receiving means receives package bids.

16. The system of claim 9 wherein the pricing means calculates said one bidder's guaranteed winning value based upon a disaggregated bidding history.

17. The system of claim 11 wherein the pricing means calculates said one bidder's guaranteed winning value based upon a disaggregated bidding history.

18. The system of claim 9 wherein the pricing means calculates said one bidder's guaranteed winning value based upon an aggregate bidding history.

19. The system of claim 11 wherein the pricing means calculates said one bidder's guaranteed winning value based upon an aggregate bidding history.

20. A method implemented in a system, said system comprising a first computer and a plurality of other computers that are located remotely from the first computer, said plurality of other computers interconnected to the first computer by a communication system, said method for determining an allocation of a plurality of items among a plurality of bidders, said items including a plurality of types of items that are related to each other as complements or substitutes, said method comprising:
receiving bids, each bid indicating items sought and an associated value;
testing whether a bidder's bid, when taken together with the bidder's prior bids, reveals a consistent set of objectives;
constraining bids so that a bid will only be accepted based upon an activity rule that utilizes the result of the testing;
determining whether to continue accepting bids based upon the received bids; and
determining an allocation of the items among the plurality of bidders based upon the received bids and outputting said allocation of the items, after a determination not to continue accepting bids.

21. The method of claim 20 wherein the plurality of items includes at least ten items. 22, The method of claim 21 wherein the testing tests whether a bidder's bid, when taken together with the bidder's prior bids, satisfies GARP.

23. The method of claim 21 wherein the testing tests whether a bidder's bid, when taken together with the bidder's prior bids, satisfies QGARP.

24. The method of claim 21 wherein the constraining constrains bids with a GARP-based activity rule.

25. The method of claim 21 wherein the constraining constrains bids with a QGARP-based activity rule.

26. The method of claim 21, further comprising calculating one bidder's guaranteed winning value associated with a package of the plurality of types of items and outputting said one bidder's guaranteed winning value, said one bidder's guaranteed winning value based upon the bids of other bidders than said one bidder and an activity rule applied to the other bidders by said constraining.

27. The method of claim 22, further comprising calculating one bidder's guaranteed winning value associated with a package of the plurality of types of items and outputting said one bidder's guaranteed winning value, said one bidder's guaranteed winning value based upon the bids of other bidders than said one bidder and an activity rule applied to the other bidders by said constraining.

28. The method of claim 23, further comprising calculating one bidder's guaranteed winning value associated with a package of the plurality of types of items and outputting said one bidder's guaranteed winning value, said one bidder's guaranteed winning value based upon the bids of other bidders than said one bidder and an activity rule applied to the other bidders by said constraining.

29. The method of claim 24, further comprising calculating one bidder's guaranteed winning value associated with a package of the plurality of types of items and outputting said one bidder's guaranteed winning value, said one bidder's guaranteed winning value based upon the bids of other bidders than said one bidder and an activity rule applied to the other bidders by said constraining.

30. The method of claim 25, further comprising calculating one bidder's guaranteed winning value associated with a package of the plurality of types of items and outputting said one bidder's guaranteed winning value, said one bidder's guaranteed winning value based upon the bids of other bidders than said one bidder and an activity rule applied to the other bidders by said constraining.

31. The method of claim 23, further comprising transmitting a price vector indicating a price for each type of item to bidders.

32. The method of claim 25, further comprising transmitting a price vector indicating a price for each type of item to bidders.

33. The method of claim 23 wherein the receiving receives package bids.

34. The method of claim 25 wherein the receiving receives package bids.

35. The method of claim 28 wherein the calculating calculates said one bidder's guaranteed winning value based upon a disaggregated bidding history.

36. The method of claim 30 wherein the calculating calculates said one bidder's guaranteed winning value based upon a disaggregated bidding history.

37. The method of claim 28 wherein the calculating calculates said one bidder's guaranteed winning value based upon an aggregate bidding history.

38. The method of claim 30 wherein the calculating calculates said one bidder's guaranteed winning value based upon an aggregate bidding history.

39. A non-transitory computer readable medium for executing a sequence of instructions recorded in said medium to perform a method implemented in a system, said system comprising a first computer and a plurality of other computers that are located remotely from the first computer, said plurality of other computers interconnected to the first computer by a communication system, said method for determining an allocation of a plurality of items among a plurality of bidders, said items including a plurality of types of items that are related to each other as complements or substitutes, said method comprising:
receiving bids, each bid indicating items sought and an associated value;
testing whether a bidder's bid, when taken together with the bidder's prior bids, reveals a consistent set of objectives;
constraining bids so that a bid will only be accepted based upon an activity rule that utilizes the result of the testing;
determining whether to continue accepting bids based upon the received bids; and
determining an allocation of the items among the plurality of bidders based upon the received bids and outputting said allocation of the items, after a determination not to continue accepting bids.

40. The medium of claim 39 wherein the plurality of items includes at least ten items.

41. The medium of claim 40 wherein the testing tests whether a bidder's bid, when taken together with the bidder's prior bids, satisfies GARP.

42. The medium of claim 40 wherein the testing tests whether a bidder's bid, when taken together with the bidder's prior bids, satisfies QGARP.

43. The medium of claim 40 wherein the constraining constrains bids with a GARP-based activity rule.

44. The medium of claim 40 wherein the constraining constrains bids with a QGARP-based activity rule.

45. The medium of claim 40 wherein the method further comprises calculating one bidder's guaranteed winning value associated with a package of the plurality of types of items and outputting said one bidder's guaranteed winning value, said one bidder's guaranteed winning value based upon the bids of other bidders than said one bidder and an activity rule applied to the other bidders by said constraining.

46. The medium of claim 41 wherein the method further comprises calculating one bidder's guaranteed winning value associated with a package of the plurality of types of items and outputting said one bidder's guaranteed winning value, said one bidder's guaranteed winning value based upon the bids of other bidders than said one bidder and an activity rule applied to the other bidders by said constraining.

47. The medium of claim 42 wherein the method further comprises calculating one bidder's guaranteed winning value associated with a package of the plurality of types of items and outputting said one bidder's guaranteed winning value, said one bidder's guaranteed winning value based upon the bids of other bidders than said one bidder and an activity rule applied to the other bidders by said constraining.

48. The medium of claim 43 wherein the method further comprises calculating one bidder's guaranteed winning value associated with a package of the plurality of types of items and outputting said one bidder's guaranteed winning value, said one bidder's guaranteed winning value based upon the bids of other bidders than said one bidder and an activity rule applied to the other bidders by said constraining.

49. The medium of claim 44 wherein the method further comprises calculating one bidder's guaranteed winning value associated with a package of the plurality of types of items and outputting said one bidder's guaranteed winning value, said one bidder's guaranteed winning value based upon the bids of other bidders than said one bidder and an activity rule applied to the other bidders by said constraining.

50. The medium of claim 42 wherein the method further comprises transmitting a price vector indicating a price for each type of item to bidders.

51. The medium of claim 44 wherein the method further comprises transmitting a price vector indicating a price for each type of item to bidders.

52. The medium of claim 42 wherein the receiving receives package bids.

53. The medium of claim 44 wherein the receiving receives package bids.

54. The medium of claim 47 wherein the calculating calculates said one bidder's guaranteed winning value based upon a disaggregated bidding history.

55. The medium of claim 49 wherein the calculating calculates said one bidder's guaranteed winning value based upon a disaggregated bidding history.

56. The medium of claim 47 wherein the calculating calculates said one bidder's guaranteed winning value based upon an aggregate bidding history.

57. The medium of claim 49 wherein the calculating calculates said one bidder's guaranteed winning value based upon an aggregate bidding history,
